(19) United States
(12) Patent Application Publication
(10) Pub. No.: US 2026/0192598 A1
(43) Pub. Date: Jul. 9, 2026

(54) Trolley for mounting, dismounting, and transporting a tire, wheel, or tire-wheel assembly

(71) Applicant: Snap-on Incorporated, Kenosha, WI (US)

(72) Inventors: Jeffrey P. Hastings, Hanover, NH (US); Christopher L. Greenwald, Waban, MA (US); Xiaoyong Liu, Shanghai (CN)

(21) Appl. No.: 19/011,532

(22) Filed: Jan. 6, 2025

(51) Int. Cl. B60B 29/00; B60B 30/00; B62B 3/14

(52) U.S. Cl. CPC B60B 29/002; B60B 29/001; B60B 30/00; B62B 3/14

(57) ABSTRACT

A trolley comprises a base having one or more base elements, a set of wheel assemblies, and a connecting plate. The trolley includes a hydraulic lift mounted upon the connecting plate, and a support plate mounted upon the hydraulic lift. The trolley includes multiple support arms attached to the support plate, and a lift actuator for altering fluid pressure within the hydraulic lift. Portions of the base element(s) diverge from each other as those portions extend in directions toward a second end of the base opposite the first end of the base. The connecting plate is mounted upon top sides of the base element(s) proximate the second end of the base. First and second support arms extend away from the support plate and substantially orthogonal to a third support arm that extends upward from the support plate. The set of wheel assemblies keep the base element(s) above a ground surface.

### BACKGROUND

According to some sources, the oldest transportation wheel, a chariot wheel dating back to 3,200 BC, was found in Mesopotamia. Years later in 1847, U.S. Pat. No. 5,104 issued to Robert W. Thomson for an improvement in carriage wheels. That patent, according to some sources, describes Thomson's invention of the pneumatic tire.

Since then tires and wheels have been used on many types of vehicles, such as cars and trucks. In this description, a combination of a tire and wheel is referred to as a tire-wheel assembly. The following tables show example specifications corresponding to some tires, wheels, and tire-wheel assemblies. Table A corresponds to tires, wheels and tire-wheel assemblies for trucks. Table B corresponds to tires, wheels and tire-wheel assemblies for cars.

TABLE A

| | | | | | | Tire and |
|---|---|---|---|---|---|---|
| | | Total | | | | Wheel |
| | Wheel | Diam- | | Tire | Wheel | Assembly |
| | size | eter | Width | Weight | Weight | Weight |
| Tire size | (inches) | (inches) | (inches) | (lbs) | (lbs) | (lbs) |
| 295/75R22.5 | 22.5 | 40.0 | 11.0 | 110 | 75 | 185 |
| 275/80R22.5 | 22.5 | 40.0 | 11.0 | 115 | 75 | 190 |
| 285/75R24.5 | 24.5 | 44.0 | 11.5 | 130 | 85 | 215 |
| 445/50R22.5 | 22.5 | 42.0 | 17.5 | 200 | 100 | 300 |

TABLE B

| | | | | | | Tire and |
|---|---|---|---|---|---|---|
| | | Total | | | | Wheel |
| | Wheel | Diam- | | Tire | Wheel | Assembly |
| | size | eter | Width | Weight | Weight | Weight |
| Tire size | (inches) | (inches) | (inches) | (lbs) | (lbs) | (lbs) |
| 195/65R15 | 15 | 25.0 | 7.7 | 21 | 20 | 41 |
| 205/55R16 | 16 | 25.5 | 8.1 | 24 | 22 | 46 |
| 215/55R17 | 17 | 26.3 | 8.5 | 27 | 25 | 52 |
| 245/45R18 | 18 | 26.7 | 9.6 | 32 | 30 | 62 |
| 275/60R20 | 20 | 33.0 | 10.8 | 45 | 40 | 85 |

Tire-wheel assemblies occasionally need to be removed from a vehicle to service the tire, the wheel, the tire-wheel assembly or another part of the vehicle. The level of difficulty in handling a tire-wheel assembly removed from a vehicle can increase relative to an increase in the size and weight of the tire-wheel assembly. A trolley can be useful to a person needing to move a tire, a wheel, or a tire-wheel assembly.

### Overview

In a first implementation, a trolley is provided. The trolley comprises a base. The base comprises first and second base elements, a set of wheel assemblies, and a connecting plate. The trolley also comprises a hydraulic lift mounted upon the connecting plate. The trolley also comprises a support plate mounted upon the hydraulic lift. Further, the trolley comprises first, second, and third support arms attached to the support plate. Furthermore, the trolley comprises a lift actuator configured to alter fluid pressure within the hydraulic lift. The first base element and the second base element diverge from each other as the first and second base elements extend in directions toward a second end of the base opposite the first end of the base. The connecting plate is mounted upon top sides of the first and second base elements proximate the second end of the base. The third support arm extends upward from the support plate. The first and second support arms extend away from the support plate and substantially orthogonal to the third support arm. The set of wheel assemblies is arranged to keep the first and second base elements above a ground surface below the first and second base elements.

In a second implementation, a trolley is provided. The trolley comprises a base. The base comprises a frame having first and second longitudinal end sides, and first and second longitudinal portions between the first and second longitudinal end sides, a set of wheel assemblies, and a connecting plate. The trolley further comprises a hydraulic lift mounted upon the connecting plate. The trolley also comprises a support plate mounted upon the hydraulic lift. Further, the trolley comprises first, second, and third support arms attached to the support plate. Furthermore, the trolley comprises a lift actuator configured to alter fluid pressure within the hydraulic lift. The first longitudinal end side is opposite the second longitudinal end side. The first longitudinal portion and the second longitudinal portion diverge from each other as the first and second longitudinal portions extend in directions toward the second longitudinal end side away from the first longitudinal end side. The connecting plate is mounted upon top sides of the first and second longitudinal portions proximate the second longitudinal end side of the frame. The third support arm extends upward from the support plate. The first and second support arms extend away from the support plate and substantially orthogonal to the third support arm. The set of wheel assemblies is arranged to keep the frame above a ground surface below the frame.

In a third implementation, a method is provided. The method includes positioning a trolley with first and second rollers underneath a tire-wheel assembly mounted on a vehicle. The method also includes adjusting an elevation of the first and second rollers and positioning a third roller to be to be in contact with the tire-wheel assembly. The method further includes moving the trolley and the tire-wheel assembly after removal of lug nuts retaining the tire-wheel assembly. Additionally, the method include positioning the trolley and the tire-wheel assembly in proximity to the wheel hub where the tire-wheel assembly is to be remounted. The method also includes rotating the tire-wheel assembly against the first, second, and third rollers to align mounting holes in the tire-wheel assembly wheel studs on a wheel hub. Further the method includes positioning the trolley for placement of the tire-wheel assembly onto the wheel hub. Furthermore, the method includes reinstalling lug nuts on wheel studs of the wheel hub to secure the tire-wheel assembly to the vehicle. Furthermore still, the method includes lowering an elevation of the first and second rollers and moving the trolley away from the tire-wheel assembly.

In a fourth implementation, a method is provided. The method comprises assembling a base comprising one or more base elements, a set of wheel assemblies, and a connecting plate. The method also includes mounting a hydraulic lift upon the connecting plate. The method also includes mounting a support plate upon the hydraulic lift. Further, the method includes attaching first, second and third support arms to the support plate. Furthermore, the method includes connecting a lift actuator to the hydraulic lift.

### BRIEF DESCRIPTION OF THE DRAWINGS

Example embodiments are described herein with reference to the drawings.

FIG. 1 is a perspective view of a trolley, in accordance with an example embodiment.

FIG. 2 is another perspective view of the trolley, in accordance with an example embodiment.

FIG. 3 is an elevation view of the trolley, in accordance with an example embodiment.

FIG. 4 is another elevation view of the trolley, in accordance with an example embodiment.

FIG. 5 is another elevation view of the trolley, in accordance with an example embodiment.

FIG. 6 is another elevation view of the trolley, in accordance with an example embodiment.

FIG. 7 is a top view of the trolley 100, in accordance with the example embodiments.

FIG. 8 is a bottom view of the trolley 100, in accordance with the example embodiments.

FIG. 9 is a partial exploded view of a trolley, in accordance with the example embodiments.

FIG. 10 is another partial exploded view of a trolley, in accordance with the example embodiments.

FIG. 11 is another partial exploded view of a trolley, in accordance with the example embodiments.

FIG. 12 is another partial exploded view of a trolley, in accordance with the example embodiments.

FIG. 13 is another partial exploded view of a trolley, in accordance with the example embodiments.

FIG. 14 shows details of a hydraulic lift, in accordance with the example embodiments.

FIG. 15 shows details of a plunger actuator and plunger actuator retainer, in accordance with the example embodiments.

FIG. 16 show a platform and bracket, in accordance with the example embodiments.

FIG. 17 show components of trolley in between a hydraulic lift and a support plate, in accordance with the example embodiments.

FIG. 18 shows details of a bracket, in accordance with the example embodiments.

FIG. 19 shows details of rollers, in accordance with the example embodiments.

FIG. 20 shows details of a support plate, in accordance with the example embodiments.

FIG. 21 shows details corresponding to a support arm, in accordance with the example embodiments.

FIG. 22 shows details of a roller bracket, in accordance with the example embodiments.

FIG. 23 shows a tie-down, in accordance with the example embodiments.

FIG. 24 is an elevation view of the trolley supporting a tire-wheel assembly, in accordance with the example embodiments.

FIG. 25 is a perspective view of a trolley, in accordance with another example embodiment.

FIG. 26 is a perspective view of a trolley, in accordance with another example embodiment.

FIG. 27 is a perspective view of a trolley, in accordance with another example embodiment.

FIG. 28 is a flow chart showing steps that can performed an a method, in accordance with the example embodiments.

FIG. 29 is a flow chart showing steps that can performed an a method, in accordance with the example embodiments.

FIG. 30 shows perspective views including details of a support shield, in accordance with the example embodiments.

All the figures are schematic, not necessarily to scale, and generally show parts which are necessary to explain example embodiments, wherein other parts may be omitted or merely suggested.

### DETAILED DESCRIPTION

### I. Introduction

This description describes several example embodiments (e.g., implementations) that pertain to a trolley. The trolley of example embodiments can be used to support and move a tire, a wheel, or a tire-wheel assembly. Movement of a tire-wheel assembly can occur while a technician is moving the tire-wheel assembly from a first position to a second position on a vehicle. Such movement is often referred to as “tire rotation.” The trolley of the example embodiments allows the tire-wheel assembly to be rotated so that lug holes within the wheel of the tire-wheel assembly can be aligned with wheel studs of a wheel hub on the vehicle. The technician using the trolley does not have to hold or support the tire-wheel assembly when rotating the tire-wheel assembly on the trolley.

Many vehicles operate with four tire-wheel assemblies. For such vehicles, the use of multiple trolleys (e.g., four trolleys) when performing the tire rotation operation is beneficial to the technician because the technician does not have to remove a tire-wheel assembly from a trolley before it is reinstalled onto the vehicle. The example embodiments include trolleys that can be nested next to one another so that an amount of space required to store multiple trolleys when not in use can be reduced relative to an amount of space taken by the multiple trolleys when not nested.

The example embodiments include a trolley in which a tire-wheel assembly is tilted back towards an upright support arm and roller. The support arm is adjustable so that the roller can contact a tire side wall of the tire-wheel assembly. The tilting of the tire-wheel assembly based on an arrangement of the support arms and rollers of the trolley reduce the likelihood of the tire-wheel assembly falling of the trolley, especially for circumstances when a tire of the tire-wheel assembly is work unevenly (e.g., a tire with tire cupping).

### II. Example Trolley

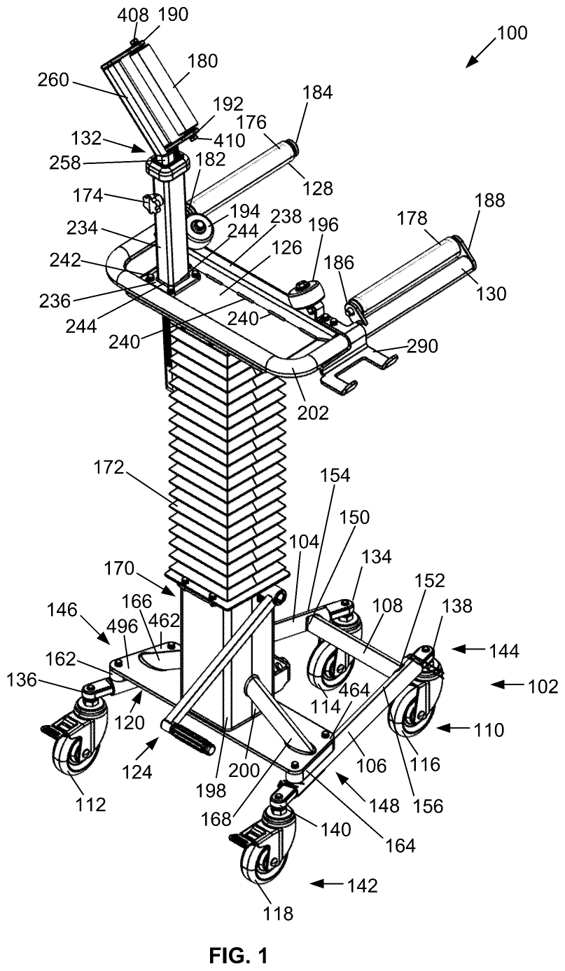

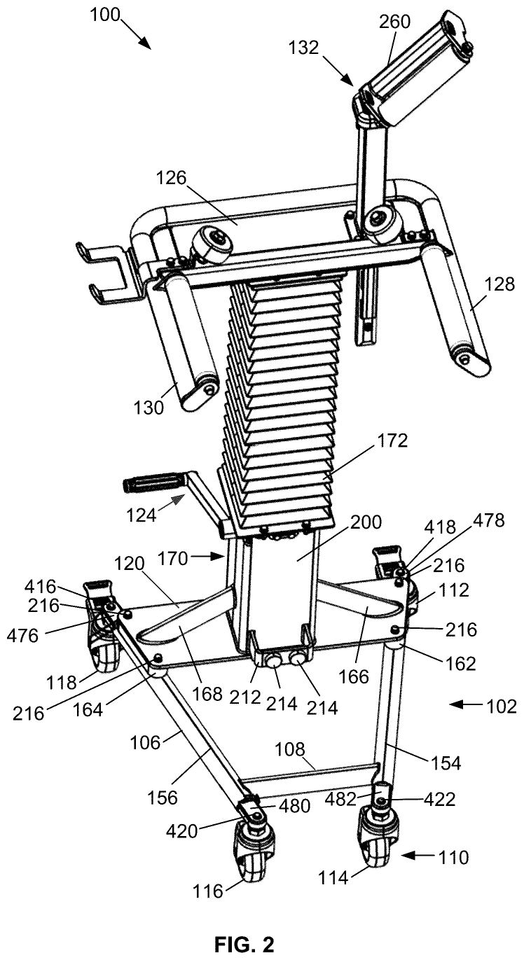

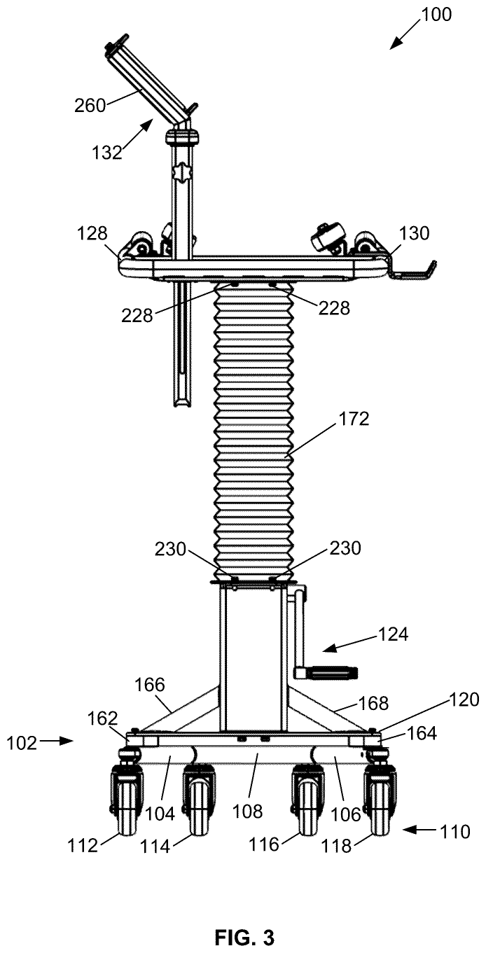

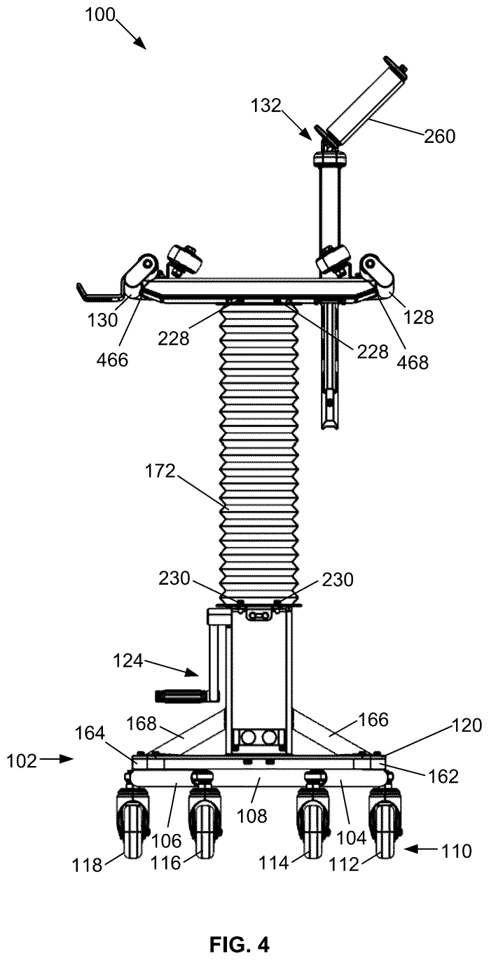

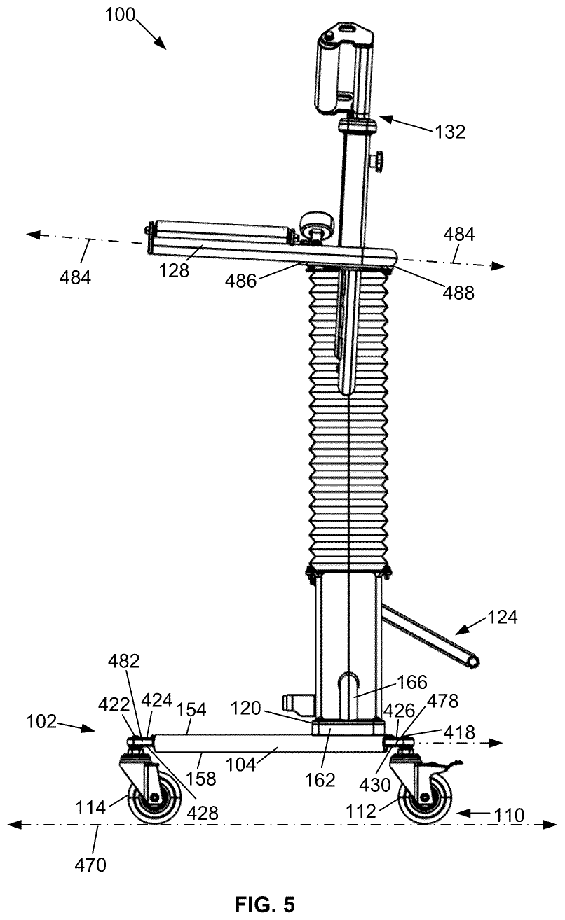

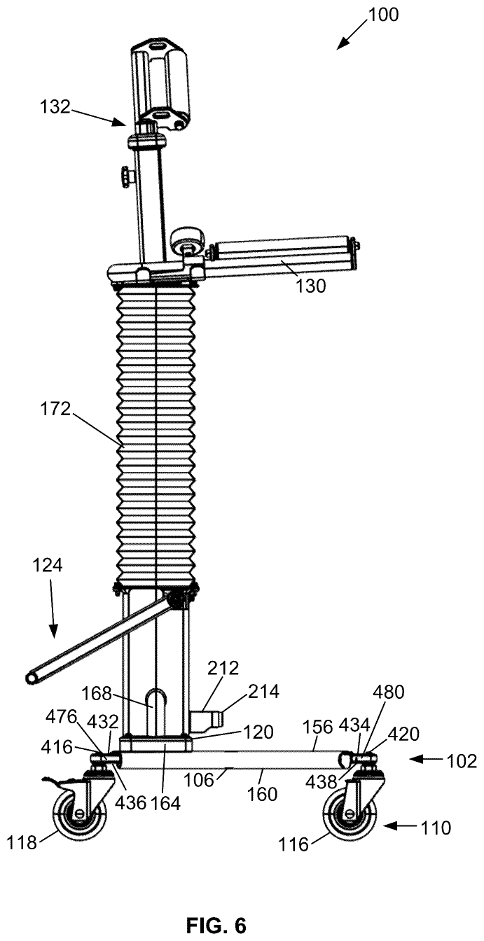

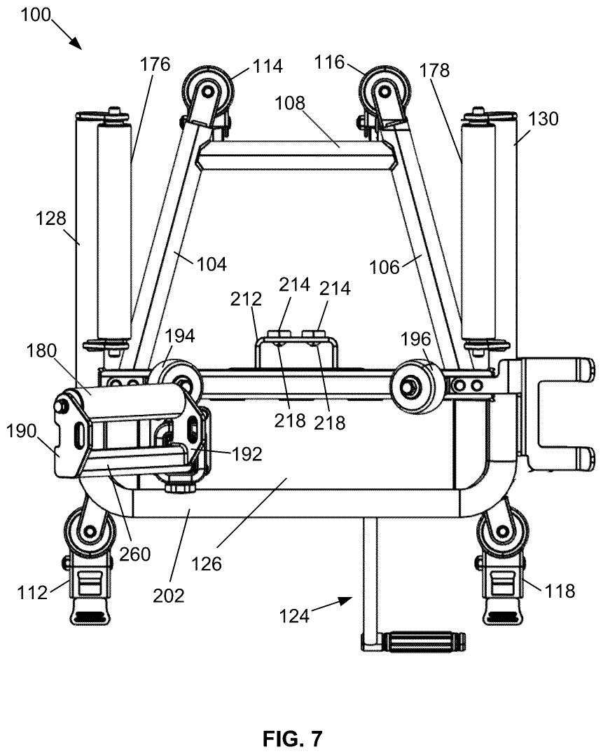

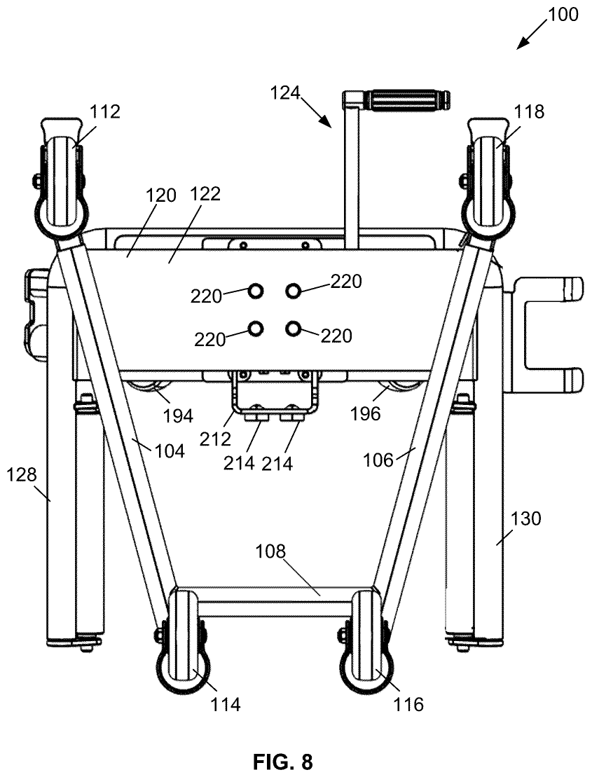

FIG. 1 is a perspective view of a trolley 100. FIG. 2 is another perspective view of the trolley 100. FIG. 3, FIG. 4, FIG. 5, and FIG. 6 are elevations views of the trolley 100. FIG. 7 is a top view of the trolley 100. FIG. 8 is a bottom view of the trolley 100.

The trolley 100 includes a base 102. The base 102 includes a first end 144 (i.e., a first end of the base 102 and/or a first end of the trolley 100) and a second end 142 (i.e., a second end of the base 102 and/or a second end of the trolley 100). The first end 144 is opposite the second end 142. The base 102 includes a first side 146 and a second side 148. The first side 146 is opposite the second side 148. Looking towards the second end 142 of the trolley 100, the first side 146 can be referred to as a left side of the base 102, and the second side 148 can be referred to as a right side of the base 102.

The base 102 includes a base element 104, a base element 106, and a base element 108. For purposes of this description, the base element 104 is sometimes and/or can be referred to as a “first base element,” the “first base element 104,” or a “first frame element.” Similarly, the base element 106 is sometimes and/or can be referred to as a “second base element,” the “second base element 106,” or a “second frame element” and the base element 108 is sometimes and/or can be referred to as a “third base element,” the “third base element 108,” or a “third frame element.” Multiple frame elements, such as the first, second, and third frame elements can form at least part of a frame.

The base element 104, 106, 108 comprises a metal stock. For example, the base element 104, 106, 108 can comprise a metal bar, a metal rod, a metal pipe, or a metal tube. As another example, the base element 104, 106, 108 can comprise a combination of two or more of the metal stock, such as a metal tube and a metal rod, or some other combination.

In accordance with at least some embodiments, the base element 104, 106 comprises metal stock. Ends of the metal stock are machined to have upper and lower flat surfaces.

The base element 108 extends between the base element 104 and the base element 106. In accordance with at least some embodiments, the base element 108 is welded to both the base element 104 and the base element 106. In accordance with at least some other embodiments, the base element 108 is attached to the base element 104 using one or more fasteners, and the base element 108 is attached to the base element 106 using one or more fasteners.

The trolley 100 includes a set of wheel assemblies 110 includes a wheel assembly 112, a wheel assembly 114, a wheel assembly 116, and a wheel assembly 118. The set of wheel assemblies 110 is arranged to keep the base element 104, the base element 106, and the base element 108 above a ground surface below the base element 104, the base element 106, and the base element 108. As an example, when the trolley 100 is located within a repair shop, the ground surface can be a surface of a floor in the repair shop.

The set of wheel assemblies 110 can be arranged in any of a variety of configurations. For example, the set of wheel assemblies 110 can be arranged such that each of the wheel assembly 112, 114, 116, 118 comprises an individual caster. In accordance with at least some embodiments based on that arrangement, one or more of the individual casters can comprise a locking caster.

For instance, the wheel assembly 112, 114 can each included an individual locking caster. As another example, one or more of the wheel assemblies of the set of wheel assemblies 110 can comprise a wheel on a fixed, non-pivoting axle. In accordance with at least some embodiments based on that arrangement, the wheel assembly 114, 116 can each comprise a wheel on a fixed, non-pivoting axle. The base element 104, 106, 108 and the set of wheel assemblies 110 can form and/or be part of a base frame assembly.

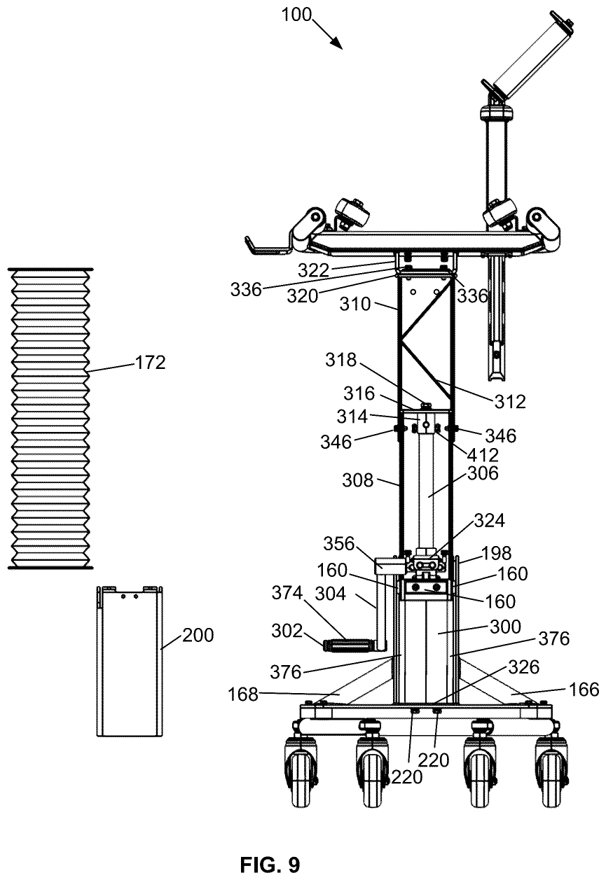

The trolley 100 includes a connecting plate 120 and a hydraulic lift 300 (shown in FIG. 9 and other figures) mounted upon the connecting plate 120. The trolley 100 includes a lift actuator 124 configured to alter fluid pressure within the hydraulic lift 300. A longitudinal end 462 of the connecting plate 120 can be disposed above the base element 104. Similarly, a longitudinal end 464 of the connecting plate 120 can be disposed above the base element 106.

The trolley 100 includes a support plate 126 mounted upon the hydraulic lift 300. In at least some embodiments, the support plate 126 is mounted upon the hydraulic lift 300 indirectly by way of one or more other trolley components to be discussed hereafter. The support plate 126 can function as a tray. A technician can place objects, such as lug nuts, a tire pressure gauge or valve stem caps, on the support plate 126 to function as a tray (e.g., a tool tray). A mat, such as a rubber mat, can be positioned on the support plate 126.

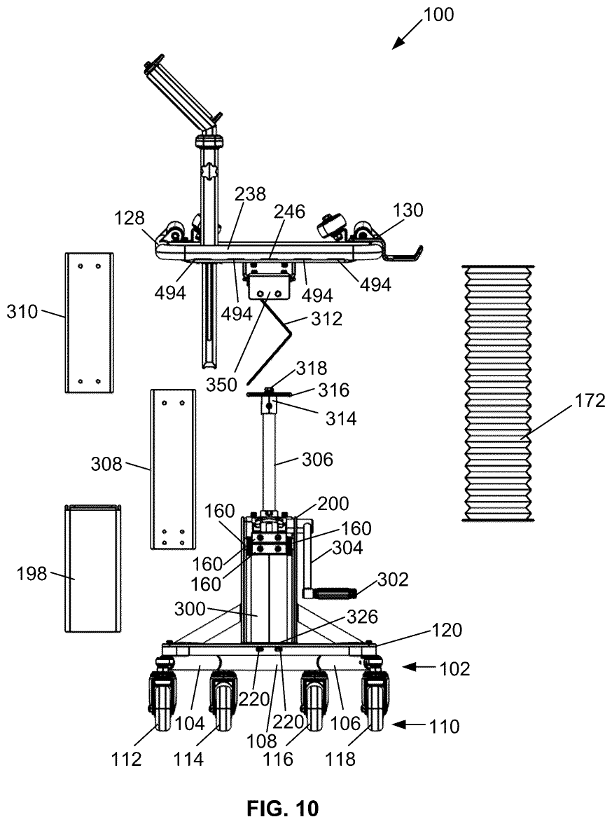

The trolley 100 includes a support arm 128, a support arm 130, a support arm 132, a support arm base 202, and a brace 238. The support arm 128, 130, 132, the support arm base 202, and the brace 238 are fixedly attached to the support plate 126. As an example, the support arm base 202 and the brace 238 can be welded to the support plate 126. Welds 240 for attaching the brace 238 to the support plate 126 are shown in FIG. 1. Welds 494 for attaching the support arm base 202 to the support plate 126 are shown in FIG. 10. As another example, the support arm 128, 130 the support arm base 202, and/or the brace 238 can attach to the support plate 126 using fasteners, such as bolts.

In accordance with at least some embodiments, the support arm 128, 130 and the support arm base 202 are made from a metal bar or pipe. In accordance with at least some embodiments, the support arm 128, 130 and the support arm base 202 are made from a single continuous piece of metal bar, rod, tube, or pipe. In those or in other embodiments, the support arm base 202 comprises a U-shaped bar, rod, tube, or pipe. The U-shaped bar, rod, tube, or pipe can be mounted on the support plate 126. The support arm 128, 130 are on opposite ends of the U-shaped bar, rod, tube, or pipe.

The support arm 128 can be referred to as a first support arm. The support arm 130 can be referred to as a second support arm. The support arm 132 can be referred to as a third support arm.

The support arm 132 extends upward from the support plate 126. The support arm 128 and the support arm 130 extend away from the support plate 126 and orthogonal or substantially orthogonal to the support arm 132. In other words, the support arm 128 and the support arm 130 can be located within a first plane and the support arm 132 can be located within a second plane. The first and second planes can be orthogonal to one another or substantially orthogonal to one another. As an example, substantially orthogonal can be within a number of degrees between 0 and 10 degrees (e.g., 0, 1, 2, 3, 4, 5, 6, 7, 8, 9, or 10 degrees).

In accordance with at least some embodiments, the support arm 128 and the support arm 130 are located within a horizontal plane and/or a plane parallel to a floor on which the trolley 100 is located. In accordance with at least some other embodiments, the support arm 128 and the support arm 130 are located within a plane that is tilted (i.e., inclined) with respect to a horizontal plane and/or a plane parallel to the floor on which the trolley 100 is located. The tilt or incline is downward, longitudinally from distal ends of the support arm 128 and the support arm 130 towards the support plate 126.

The trolley 100 includes a sleeve 234 for supporting the support arm 132. As an example, the sleeve 234 can comprise a metal tube, such as a square metal tube. As another example, the sleeve 234 can comprise a metal C-channel and plate

The sleeve 234 can be attached to the support plate 126 using a bracket 236. Welds 244 can affix the sleeve 234 to the bracket 236. The bracket 236 can be attached to the support plate 126 using fasteners 242, such as bolts or screws, or via welds. The fasteners 242 can be disposed within mounting holes 226 (shown in FIG. 20).

The base element 104 includes a longitudinal end 134 (i.e., a first longitudinal end, and/or a first longitudinal end of the base element 104) and a longitudinal end 136 (i.e., a second longitudinal end and/or a second longitudinal end of the base element 104). The longitudinal end 134 and the longitudinal end 136 are opposite one another.

The base element 106 includes a longitudinal end 138 (i.e., a first longitudinal end and/or a first longitudinal end of the base element 106) and a longitudinal end 140 (i.e., a second longitudinal end and/or a second longitudinal end of the base element 106). The longitudinal end 138 and the longitudinal end 140 are opposite one another.

The base element 108 includes a longitudinal end 150 (i.e., a first longitudinal end, a first longitudinal end of the base element 108, and/or a first longitudinal end of the third base element) and a longitudinal end 152 (i.e., a second longitudinal end, a second longitudinal end of the base element 108, and/or a second longitudinal end of the third base element). The longitudinal end 150 and the longitudinal end 152 are opposite one another. The base element 108 can be included within the base 102 and the trolley 100 as a strengthening mechanism.

The longitudinal end 150 of the base element 108 is fixedly attached to the base element 104 proximate a first end of the base element 104 (e.g., at or proximate the longitudinal end 134). In this regard, proximate the first end of the base element 104 can be a portion of base element 104 closer to the longitudinal end 134 than to the longitudinal end 136. More particularly, proximate the first end of the base element 104 can, for example, be a portion of base element 104 between the longitudinal end 134 and a portion of the base element 104 below the spacer 162. The longitudinal end 152 of the base element 108 is fixedly attached to the base element 106 proximate the first end of the base element 106 (e.g., at or proximate the longitudinal end 138). In this regard, proximate the first end of the base element 106 can be a portion of base element 106 closer to the longitudinal end 138 than to the longitudinal end 140. More particularly, proximate the first end of the base element 106 can, for example, be a portion of base element 106 between the longitudinal end 138 and a portion of the base element below the spacer 164.

The base element 104 extends longitudinally from or proximate the first end 144 to or proximate the second end 142. As an example, for the base element 104, proximate the first end 144 can comprise an area above the wheel assembly 114, and proximate the second end 142 can comprise an area above the wheel assembly 112. Similarly, the base element 106 extends longitudinally from or proximate the first end 144 to or proximate the second end 142. As an example, for the base element 106, proximate the first end 144 can comprise an area above the wheel assembly 116, and proximate the second end 142 can comprise an area above the wheel assembly 118. The base element 104 and the base element 106 diverge from each other as both the base element 104 and the base element 106 extend in directions toward the second end 142 of the base 102 opposite the first end 144 of the base 102.

The connecting plate 120 is mounted upon a top side 154 of the base element 104 and a top side 156 of the base element 106, proximate the second end 142 of the base 102. In this regard, proximate the second end of the base 102 can be a portion of base 102 closer to the longitudinal end 136, 140 than to the longitudinal end 134, 138. More particularly, proximate the second end of the base 102 can be a portion of the base between the longitudinal end 134, 138 and a mid-point of the base element 104, 106. Any portion of connecting plate 120 can be disposed proximate the second end of the base 102. The spacer 164 is disposed between the base element 104 and the connecting plate 120 and contacts the top side 154 of the base element 104 and a bottom side 122 of the connecting plate 120. The bottom side 122 is shown in FIG. 8. The spacer 164 is disposed between the base element 106 and the connecting plate 120 and contacts the top side 156 of the base element 106 and the bottom side 122 of the connecting plate 120.

Use of the spacer 162, 164 allows portions of base elements (e.g., the base elements 104, 106, 108) of a second trolley arranged like the trolley 100 can pass under the connecting plate 120 and in between the base element 104 and the base element 106 of the trolley. In other words, of the spacer 162, 164 provides clearance to allow base elements of another similarly-arranged trolley to pass under the connecting plate 120 and in between the base element 104 and the base element 106 of the trolley. Other means for providing such clearance is also possible, such as the wheel assembly 114, 116 being shorter than the wheel assembly 112, 118, placing shims between the wheel assembly 112 and the base element 104 and between the wheel assembly 118 and the base element 106, or having the base element 104, 106 slant downward as it extends longitudinally from the second end 142 to the first end 144.

In accordance with at least some embodiments, the spacer 162 is welded to the base element 104, and the spacer 164 is welded to the base element 106. In accordance with at least some of those embodiments, the connecting plate 120 is fastened to the spacer 162 and the spacer 164. That fastening can occur via fasteners 216 (identified in FIG. 2) installed through a top side 496 of connecting plate 120 into through-holes within the connecting plate and into threaded holes within the spacer 162, 164. In accordance with at least some other embodiments, the connecting plate 120 is fastened to the base element 104 and the base element 106. That fastening can occur via fasteners 216 installed through a top side 496 of connecting plate 120 into through-holes within the connecting plate, into through-holes within the spacer 162, 164 and into threaded holes within the base element 104, 106.

In accordance with at least some embodiments, the base element 104 and the base element 106 extend upward as the base element 104 and the base element 106 extend in directions towards the second end 142 of the base 102 opposite the first end 144 of the base 102. This arrangement of the base 102 provides clearance to allow base elements of another similarly-arranged trolley to pass under the connecting plate 120 and in between the base element 104 and the base element 106 of the trolley. Placing trolleys together in this manner can be referred to as nesting the trolleys.

The upward extension of the base element 104, 106 can be implemented in various ways. For example, the upward extension of the base element 104, 106 can be implemented by having the wheel assembly 112, 118 being larger than the wheel assembly 114, 116. As another example, the upward extension of the base element 104, 106 can be implemented by the placement of shim(s) between the wheel assembly 112 and the base element 104 and shim(s) between the wheel assembly 118 and the base element 106. The upward extension of the base element 104, 106 can be implemented instead of or in addition to use of the spacer 162, 164.

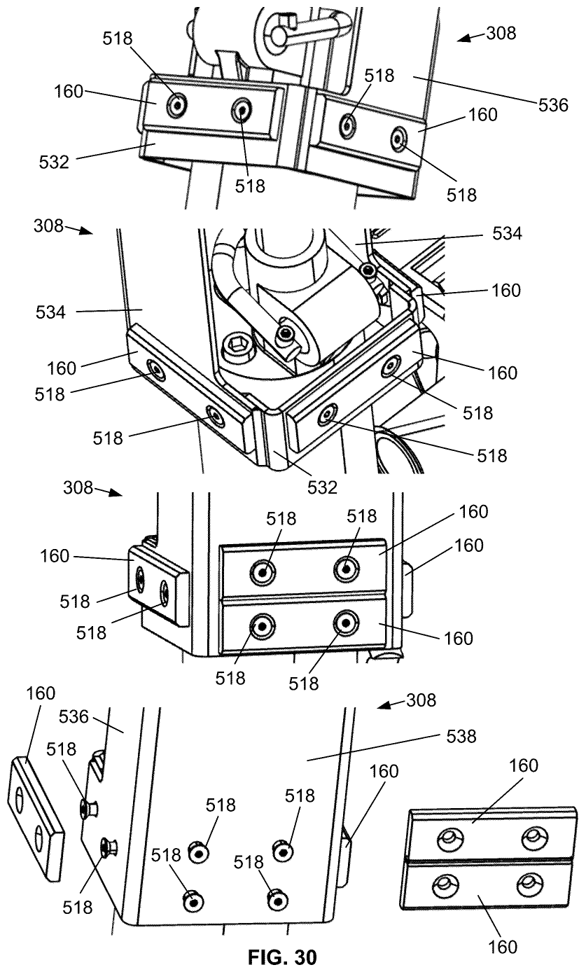

The trolley 100 can include a shield 170 (i.e., a hydraulic lift shield) configured to transmit lateral forces from a wheel on the trolley 100 to the base 102. In at least some arrangements, a piston 306 (shown in FIG. 9) of the hydraulic lift 300 provides a vertical force. The lateral forces transferred to the shield 170 can be transferred to the shield 170 via a set of plain bearings (e.g., a plain bearing 160 shown in FIG. 9, FIG. 10, and FIG. 30). The transfer of forces by the set of plain bearings and the shield 170 eliminates/reduces any twisting moment on the piston or the seals (e.g., piston seals) within the hydraulic lift.

The shield 170 can comprise multiple shield components. For example, the shield 170 can include a shield component 198, 200. One or more of the shield component 198, 200 can comprise a metal C-channel, such as a steel or aluminum C-channel. A size of the shield component 198, 200 can be selected based on a diameter of the of the trolley 100. As an example, the C-channel can have a width of four inches, a depth of two includes and a thickness of 0.375 inches, 0.5 inches, or .625 inches. Other dimensions of a C-channel used for the shield component 198, 200 are also possible.

The trolley 100 can include one or more braces attached to the connecting plate 120 and to the shield 170. As an example, the trolley 100 can include a brace 166, 168 attached to the connecting plate 120 and to the shield 170. The brace 166 extends from the shield 170 towards the connecting plate 120 and base element 104. Similarly, the brace 168 extends from the shield 170 towards the connecting plate 120 and base element 106. The brace 166, 168 can limit stress on weldments of the shield 170 to the connecting plate 120.

In at least some embodiments, the brace 166, 168 is fixedly attached to the connecting plate 120 and to the shield 170. As an example, that attachment can occur by welding first ends of the brace 166, 168 to the shield 170, and welding second ends of the brace 166, 168 to the connecting plate 120.

The trolley 100 can include a shield 172 (i.e., an accordion shield). The shield 172 can protect components covered by the shield 172 from dust and dirt. The shield 172 can prevent access to moving components covered by the shield 172 when the shield 172 is attached to the trolley 100. The shield 172 can be configured to collapse when a piston 306 (shown in FIG. 9) is lowered and to expand when the piston 306 is raised. The piston 306 can be referred to as a “hydraulic cylinder,” a “ram,’ or by other terms. The shield 172 can be referred to as flexible folding shield.

The trolley 100 includes a roller 176, 178, 180 and a roller bracket 182, 184, 186, 188, 190, 192. In accordance with at least some embodiments, the roller 176, 178, 180 are identical. In accordance with at least some other embodiments, the roller 176 is identical to the roller 178, but different than the roller 180. In accordance with at least some embodiments, the roller 176, 178, 180 includes one or more fixed shafts or axles with shaft ends configured to rotate about bushings or bearings in corresponding roller brackets.

The roller 176 is attached to the support arm 128 via the roller bracket 182, 184 and corresponding fasteners. Similarly, the roller 178 is attached to the support arm 130 (e.g., the second portion 260 of the support arm 132) via the roller bracket 186, 188 and corresponding fasteners. The roller bracket 182 can be identical to the roller bracket 186. The roller bracket 184 can identical to the roller bracket 188. The roller 180 is attached to the support arm 132 via the roller bracket 190, 192 and fasteners 408, 410, respectively. A first portion 258 of the support arm 132 is identified in FIG. 1.

The trolley 100 includes a locking fastener 174. In accordance with at least some embodiments, the locking fastener 174 can be loosened such that the support arm 132 can be raised or lowered (i.e., a height of the support arm 132 is adjustable). The locking fastener 174 can be tightened such that the support arm 132 remains at a fixed height after being raised or lowered. As an example, a position of the support arm 132 is adjustable so that the roller 180 can be positioned in contact with at least a portion of a sidewall of a tire positioned on the roller 176 and the roller 178. As an example, the support arm 132 can be raised when the trolley 100 is supporting or will be used to support a relatively large (height-wise) tire-wheel assembly such that a height-wise center of the roller 180 can contact a tire sidewall at a mid-point between an outer-most perimeter of the tire sidewall and an inner-most perimeter of the tire sidewall or at a point close to that mid-point to achieve optimum rollability of the roller 180 for the particular tire-wheel assembly.

The trolley 100 includes a roller 194, 196 attached to the support plate 126. The roller 194, 196 can be positioned so that the roller 194, 196 contacts at least a portion of a sidewall of a tire positioned on the roller 194, 196 or a wheel to which the tire is mounted. The roller 194, 196 can be referred to as a “supplemental roller.” The roller 194, 196 can ease rotation of the tire or the tire-wheel assembly installed on the roller 194, 196.

The trolley 100 also includes a bracket 290. The bracket 290 is configured to support an impact wrench, such as a pneumatic impact wrench or a battery-operated impact wrench. A technician may place the impact wrench on the bracket 290 when not in use to remove or reinstall lug nuts from a vehicle. The bracket 290 can be referred to as a wrench bracket, pneumatic wrench bracket, or an electric wrench bracket.

FIG. 2 is another perspective view of the trolley 100. Additional components of the trolley 100 identified in FIG. 2 include the fasteners 216, a bumper bracket 212, bumpers 214, and fasteners 416, 418, 420, 422. The bumper bracket 212 can be welded to the shield component 200 of the shield 170. The bumpers 214 comprise rubber bumpers. The bumpers 214 can prevent or reduce metal to metal contact when the trolley is nested with a similar trolley by moving the first end 144 of the base 102 underneath the connecting plate 120 of the other similarly arranged trolley. Although the bumper 214 are shown as circular discs, the bumpers 214 can take a different shape such as rectangular. Additionally, the bumpers 214 can be made of a material other than rubber, such as plastic or some other material. The fasteners 416, 420 are used to attach wheel assemblies 118, 116, receptively, to the base element 106. The fasteners 418, 422 are used to attach wheel assemblies 112, 110, receptively, to the base element 104.

FIG. 2 also shows the trolley 100 can include a mounting extension 476, 478, 480, 482. The mounting extension 476, 480 extends a length of the base element 106. The mounting extension 476, 480 can be welded or otherwise attached to the base element 106. The mounting extension 478, 482 extends a length of the base element 104. The mounting extension 478, 482 be welded or otherwise attached to the base element 106. In some embodiments, the base element 106 includes a metal tube or pipe having two open ends for placement of a portion of the mounting extension 476, 480, and the base element 104 includes a metal tube or pipe having two open ends for placement of a portion of the mounting extension 478, 482. The base element 104 can include the mounting extension 478 and the mounting extension 482. Similarly, the base element 106 can include the mounting extension 476 and the mounting extension 480.

The mounting extension 476 is attached to the wheel assembly 118 via the fastener 416 and is partially positioned within an open end of the base element 106. The mounting extension 478 is attached to the wheel assembly 112 via the fastener 418 and is partially positioned within an open end of the base element 104. The mounting extension 480 is attached to the wheel assembly 116 via the fastener 420 and is partially positioned within another open end of the base element 106 The mounting extension 482 is attached to the wheel assembly 114 via the fastener 422 and is partially positioned within another open end of the base element 104.

FIG. 3 is a first elevation view of the trolley 100. The components referenced by numbers in FIG. 3 are described elsewhere in this description. Additional components of the trolley 100 identified in FIG. 3 include the fasteners 228, 230. The fasteners 228 are used to attach the shield 170 to the support plate 126. The fasteners 230 are used to attach the shield 172 to the shield 170. As an example, the fasteners 228, 230 can be comprise screws or bolts.

FIG. 4 is a second elevation view of the trolley 100. The components referenced by numbers in FIG. 4 are described elsewhere in this description. Additional components of the trolley 100 identified in FIG. 4 include an end 466, 468 of the support plate 126. The end 466 is opposite the end 468.

FIG. 5 is a third elevation view of the trolley 100. Additional components of the trolley 100 identified in FIG. 5 include a flat surface 424, 426, 428, 430 on the base element 104, a line 484 representing a plane that passes through the support arm 128, 130, and a line 470 representing a ground surface upon which the set of wheel assemblies 110 are positioned. The end 486 is opposite the end 488. The plane represented by the line 484 and the ground surface represented by the line 470 are parallel to each other or substantially parallel to one another. As an example, the plane represented by the line 484 and ground surface when substantially parallel to one another can be offset by a number of degrees between 0 and 10 degrees (e.g., 0, 1, 2, 3, 4, 5, 6, 7, 8, 9, or 10 degrees). The other components referenced by numbers in FIG. 5 are described elsewhere in this description.

The wheel assembly 114 (e.g. a caster) contacts the flat surface 428 and the fastener 422 (e.g., a bolt or bolt and washer) contacts the flat surface 424. The wheel assembly 112 (e.g. a caster) contacts the flat surface 430 and the fastener 418 (e.g., a bolt or bolt and washer) contacts the flat surface 426.

FIG. 6 is a fourth elevation view of the trolley 100. Additional components of the trolley 100 identified in FIG. 6 include a flat surface 432, 434, 436, 438 on the base element 106. The other components referenced by numbers in FIG. 6 are described elsewhere in this description.

The wheel assembly 118 (e.g. a caster) contacts the flat surface 436 and the fastener 416 (e.g., a bolt or bolt and washer) contacts the flat surface 432. The wheel assembly 116 (e.g. a caster) contacts the flat surface 438 and the fastener 420 (e.g., a bolt or bolt and washer) contacts the flat surface 434.

FIG. 7 is a top view of the trolley 100. Additional components of the trolley 100 identified in FIG. 7 include fasteners 218 used to attach the bumpers 214 to the bumper bracket 212. The other components referenced by numbers in FIG. 7 are described elsewhere in this description.

FIG. 8 is a bottom view of the trolley 100. Additional components of the trolley 100 identified in FIG. 8 include the bottom side 122 of the connecting plate 120, and fasteners 220 used to attach the hydraulic lift 300 to the connecting plate 120. As an example, the fasteners 220 can include bolts and washers. Other components referenced by numbers in FIG. 8 are described elsewhere in this description.

Next, FIG. 9 to FIG. 13 are partial exploded views of the trolley 100.

In particular, FIG. 9 is a partial exploded view of the trolley 100 when looking towards an unobstructed view of the first end 144 of the base 102 (for example, the view shown in FIG. 4). The shield 172 and the shield component 200 are removed from the trolley 100 such that other aspects of the trolley 100 can be seen. For example, FIG. 9 shows a hydraulic lift 300 including a piston 306.

FIG. 9 also shows a support shield 308, a support shield extension 310, a brace 312, a tube 314, a platform 316, 320, a fastener 318, a bracket 322, 324, and a bolt 412. The tube 314 is attached to the platform 316, for example by a weld, and to the piston 306 via the bolt 412. The platform 316 is attached to the support shield 308. As an example, the support shield 308 and the platform 316 can be welded to one another or attached to each other using fasteners, such as bolts and nuts. The fastener 318 is used to attach the platform 316 to the hydraulic lift 300 (e.g., by attachment to the piston 306). The bracket 324 holds the sleeve 356, the lever arm 304 and pedal 302 in place. The connecting plate 120, the brace 166, 168, the shield 170, the support shield 308, and the support shield 310 can form and/or be part of a column assembly.

The support shield 308 can support the support shield extension 310 and the bracket 322 and components of the trolley 100 attached to the bracket 322, as well as a tire-wheel assembly disposed upon the roller 176, 178. The support shield 308 can have dimensions that permit portions of the support shield 308 to travel into and out of a gap 376 between the hydraulic lift 300 and interior surfaces of the shield 170 (e.g., interior surfaces of the shield component 198, 200) when the hydraulic lift 300 is used to lower and raise the support plate 126, respectively.

To prevent and/or to reduce lateral movement of the support shield 308 with respect to the shield 170 (e.g., the shield component 198, 200), plain bearings can be included within the trolley 100. For example, the trolley 100 includes a plain bearing on multiple sides of the support shield 308. FIG. 9 shows a plain bearing 160 on three sides of the support shield 308. FIG. 10 shows a plain bearing 160 on three sides of the support shield 308, one side different than shown in FIG. 9.

The plain bearing 160 guide the support shield 308 as it moves through the gap 376 as the piston 306 is raised and lowered. The plain bearing 160 can contact an inner side of the shield 170. Additionally, the plain bearing 160 can provide stability to the trolley 100 as the plain bearing can take lateral forces. As an example, the plain bearing 160 can be formed from polyethylene (e.g., a high molecular weight polyethylene).

FIG. 30 shows perspective views including details of the support shield 308. As shown in FIG. 30, the support shield includes a side 534, a side 536 opposite the side 536, and a side 538 extending between the side 534 and the side 536. A bracket 532 is welded to the side 534 and the side 536 of the shield 308 is another side of the support shield 308. FIG. 30 also shows at least one plain bearing 160 on each side of the support shield 308. The plain bearing 160 can be attached to the support shield 308 using a fastener 518 (e.g., a screw). In an alternative arrangement, one more plain bearing 160 could be disposed on an inner wall of the shield 170.

Returning to FIG. 9, the support shield extension 310 can support the bracket 322 and components of the trolley 100 attached to the bracket 322, as well as a tire-wheel assembly disposed upon the roller 176, 178. The brace 312 increases the rigidity of the support shield extension 310. The support shield extension 310 can be referred to as an extension column weldment.

The support shield extension 310 can be attached to the support shield 308 using fasteners 346. As an example, the fasteners 346 can include threaded nuts welded to interior walls of the support shield 308 and threaded bolts. When the support shield 308 and the support shield extension 310 are attached to the trolley 100, the fasteners 346 can pass through through-holes within the support shield 308 and within the support shield extension 310 and into the threaded nuts.

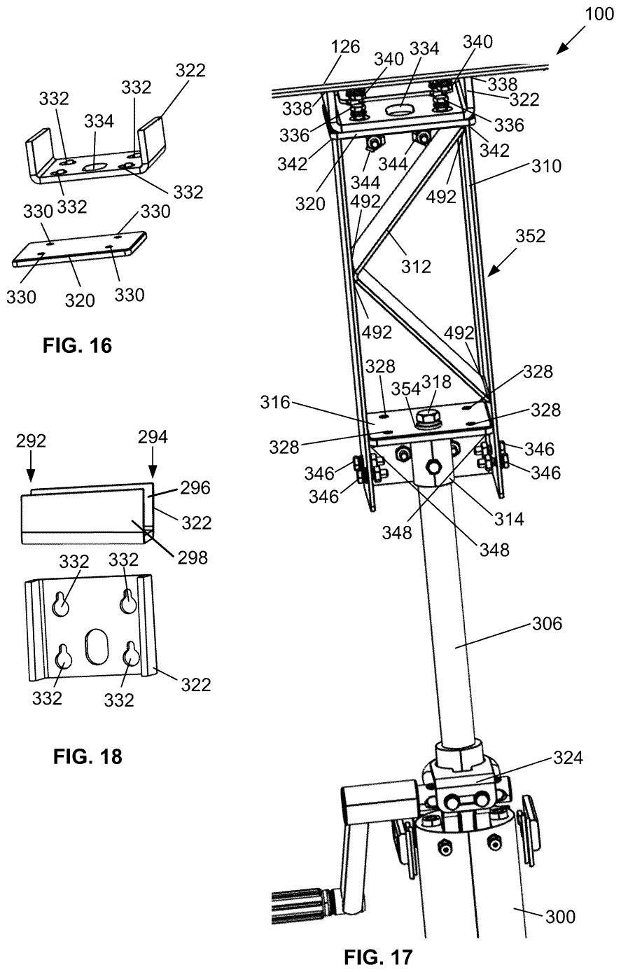

The support shield extension 310 and the platform 320 can be welded to one another or attached to each other using fasteners, such as bolts and nuts. As such, the support shield extension 310 can include the platform 320. The support shield extension 310 can be attached to the platform 320 (i.e., the support shield extension 310) using fasteners 336. Details of the platform 320 are shown in FIG. 16.

The support shield extension 310 can include the bracket 322 so that the support shield extension attaches directly to the support plate 126. Alternatively, the support shield extension 310 attaches to the support plate 126 indirectly by use of the bracket 322.

The trolley 100 can be configured so that the support shield extension 310 can be removed to reduce a maximum achievable height of the support plate 126 and the roller 176, 178 upon which a tire-wheel assembly can be disposed. Accordingly, the support shield extension 310 can be referred to as a “spacer” or a “removable spacer.”

The lift actuator 124 can include a pedal 302, a lever arm 304, and a sleeve 356. In accordance with at least some embodiments, two or more of the pedal 302, the lever arm 304, and the sleeve 356 are formed together, such as by casting. In accordance with at least some other embodiments, two or more of the pedal 302, the lever arm 304, and the sleeve 356 are formed separate and attached to each other thereafter. As an example, two or more of the pedal 302, the lever arm 304, and the sleeve 356 are welded to each other. As another example, fasteners, such as bolts or screws, can be used to attach two or more of the pedal 302, the lever arm 304, and the sleeve 356 to each other. In accordance with at least some embodiments, a grip 374 is attached to the pedal 302. The grip 374 can provide a no-slip or low-slip surface a user of the trolley 100 can contact with a shoe worn on their foot. The fasteners 220 can be installed into a base 326 of the hydraulic lift 300. The pedal 302, the lever arm 304, and the sleeve 356 can be referred to as a pedal assembly.

The lift actuator 124 and the hydraulic lift 300 can be configured so that the lift actuator 124 (e.g., the pedal 302) can be pumped to cause the piston 306 to rise if not at its maximum height. The lift actuator 124 and the hydraulic lift 300 can also be configured so that the lift actuator 124 (e.g., the pedal 302) can be pressed down (e.g., pressed down further than a downward motion to pump the lift actuator 124) to cause the piston 306 to descend if not at its lowest travel point within the hydraulic lift 300.

The lift actuator 124 can be switched to the opposite side of the shield 170. The lift actuator 124 is operable when it on either side of the shield 170.

The use of the shield 170 and the set of plain bearings (e.g., the plain bearing 160) reduce or eliminate non vertical forces applied to the hydraulic lift 300 and/or the piston 306, because a bending moment applied to the hydraulic lift 300 and/or the piston 306 can cause misalignment of seals within the hydraulic lift 300. Accordingly, the use of the shield 170 and the set of plain bearings can help prevent or delay the leaking of fluid around the seals. The shield 170 and the set of plain bearings can be referred to as a lateral force carrying structure.

Additionally, the use of the shield 170 and the set of plain bearings increases stability of the trolley 100, especially when a tire, a wheel, or a tire-wheel assembly is positioned upon the trolley 100 (e.g., positioned on the roller 176 and the roller 178) and a center of mass of the trolley 100 and the tire, wheel or tire-wheel assembly is offset from the hydraulic lift 300.

FIG. 10 is another partial exploded view of the trolley 100. Additional components of the trolley 100 identified in FIG. 10 include welds 494 that attach the brace 238 to the support plate 126, and a bracket 350. Other components referenced by numbers in FIG. 10 are described elsewhere in this description. FIG. 10 shows the brace 312 separated from the support shield extension 310 for illustration purposes in the partial exploded view of the trolley 100. The bracket 350 increases the rigidity of the support shield extension 310 and the bracket 322. The bracket 350 can provide reinforcement to a cradle assembly formed, at least in part, by the support plate 126, the support arm 128, 130, the support arm base 202, and the roller 176, 178. The bracket 350 can be referred to as a cradle reinforcement plate.

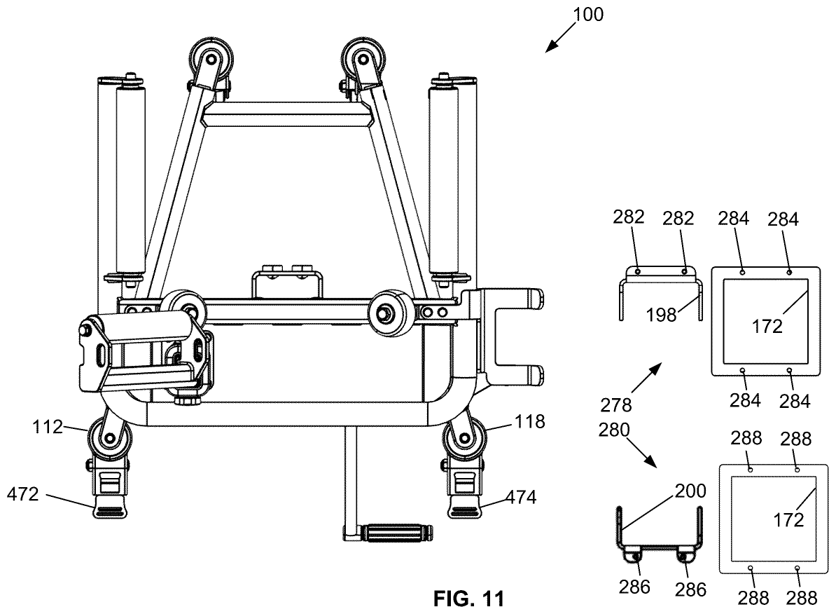

FIG. 11 is another partial exploded view of the trolley 100. In particular, FIG. 11 shows the trolley 100 with the shield 172 and the shield component 198, 200 removed from the trolley 100. Additionally, FIG. 11 shows a view 278 showing a top view of the shield 172 and the shield component 198, and a view 280 showing a bottom view of the shield 172 and the shield component 200. As shown in the view 278 and the view 280, the shield component 198 includes mounting holes 282, the shield component 200 includes mounting holes 286, and an upper end of the shield 172 include mounting holes 284 and a lower end of the shield 172 includes mounting holes 288. The mounting holes 284 allow for fasteners 228 (shown in FIG. 3 and FIG. 4) to attach the shield 172 to the support plate 126. The mounting holes 282, 284 and the mounting holes 288 allow for fasteners 230 (shown in FIG. 3 and FIG. 4) to attach the shield 172 to the shield component 198, 200. FIG. 11 also shows the trolley 100 includes a wheel assembly lock 472, 474. The wheel assembly lock 472, 474 can prevent or reduce the likelihood of the wheel assembly 112, 118 from turning when the wheel assembly lock 472, 474 is applied. The wheel assembly lock 472, 474 can be released to allow the wheel assembly 112, 118 to roll easier. In this arrangement, the wheel assembly 112, 118 can comprise a locking caster.

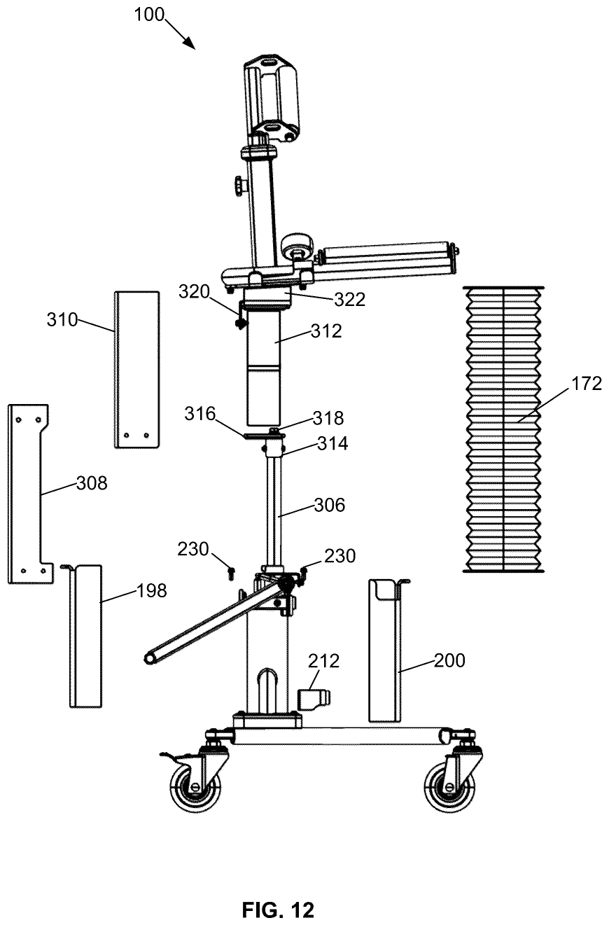

FIG. 12 is another partial exploded view of the trolley 100. The components referenced by numbers in FIG. 12 are described elsewhere in this description.

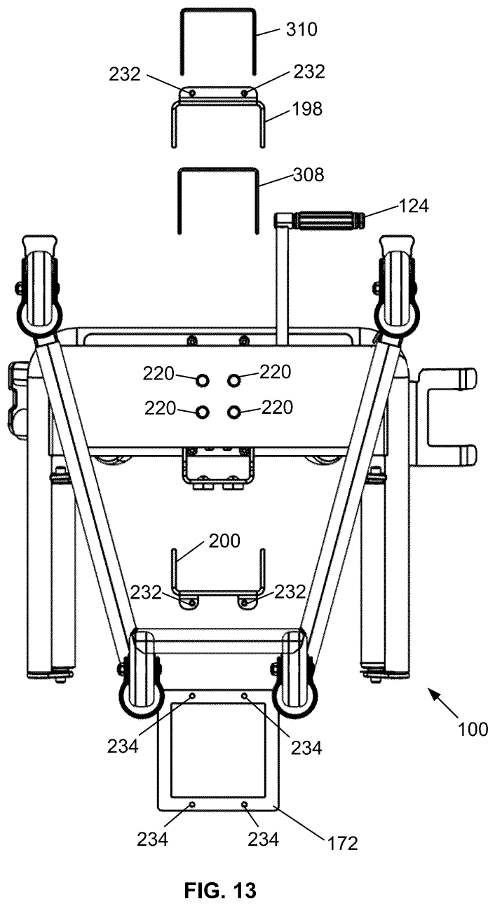

FIG. 13 is another partial exploded view of the trolley 100. The components referenced by numbers in FIG. 12 are described elsewhere in this description.

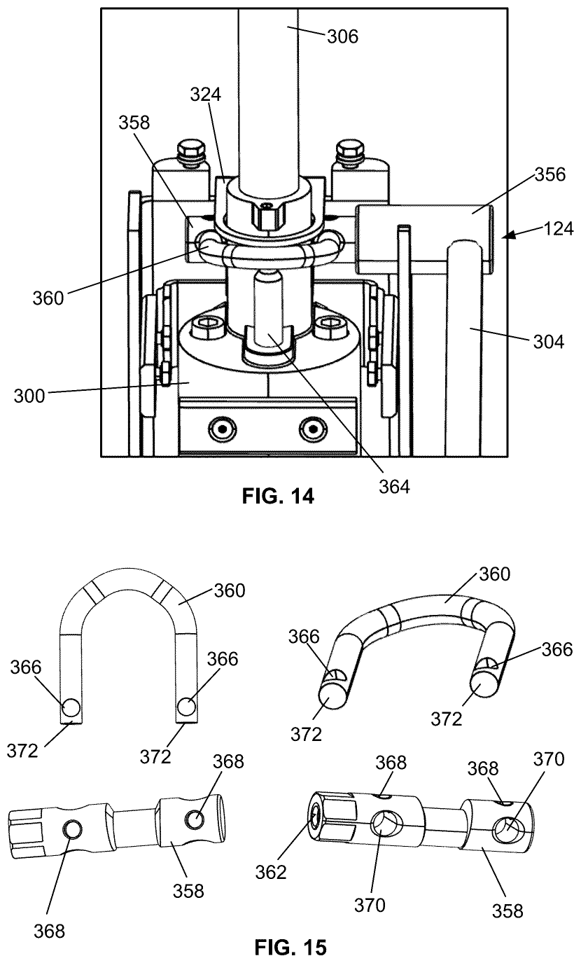

Next, FIG. 14 to FIG. 22 are detail views showing details of various components of the trolley 100.

For example, FIG. 14 shows details of and in proximity to a portion of the hydraulic lift 300. In that regard, FIG. 14 shows the piston 306, a plunger 364, and components of the lift actuator 124, such as the lever arm 304, a sleeve 356, a plunger actuator 360, and a plunger actuator retainer 358. Movement of the lever arm 304 causes the sleeve 356, the plunger actuator retainer 358, and the plunger actuator 360 such that the plunger 364 moves up or down.

FIG. 15 shows multiple view of the plunger actuator 360 and multiple views of the plunger actuator retainer 358. As shown in FIG. 15, the plunger actuator retainer 358 can include a hole 362, such as a threaded hole for receiving a fastener disposed within the sleeve 356. In an alternative arrangement, the sleeve 356 is press-fit onto the plunger actuator retainer 358.

The plunger actuator 360 includes ends 372 and holes 366 for receiving fasteners for retaining the plunger actuator 360 and the plunger actuator retainer 358 to each other. As an example, the holes 366 can be threaded the fasteners disposed therein are set screws. As another example, the holes 366 are through-holes and the fasteners disposed therein are threaded bolts secured therein using threaded nuts.

The plunger actuator retainer 358 can include a hole 362 for receiving a fastener, such as a set screw or a threaded bolt placed within sleeve 356. The plunger actuator retainer 358 includes holes 368, and holes 370 for placement of the ends 372 of the plunger actuator 360 such that the holes 368 align with the holes 366 within the plunger actuator 360 so that fasteners can be positioned within the holes 366 and 368 for attachment of the plunger actuator retainer 358 and the plunger actuator to each other. In an alternative arrangement, the ends 372 of the plunger actuator 360 are threaded such that the plunger actuator 360 can be retained at the plunger actuator retainer 358 using threaded nuts after the ends 372 pass through the holes 370.

Next, FIG. 16 shows the platform 320 and the bracket 322. The platform 320 includes mounting holes 330 for placement of fasteners 336 (shown in FIG. 17). The bracket 322 includes mounting holes 332 for placement of the fasteners 336. The bracket 322 also includes a clearance hole 334 to provide clearance for the fastener 318 for situations in which the support shield extension 310 is removed from the trolley 100 to lower a maximum achievable height of the trolley 100. The mounting holes 330, 332 can comprise through-holes. The mounting holes 330 can be tapped. The mounting holes 332 can be tapped.

FIG. 17 shows components of the trolley 100 from an upper portion of the hydraulic lift 300 to a bottom portion of the support plate 126, but with the shield 170 and the support shield 308 removed.

As shown in FIG. 17, the trolley 100 includes fasteners 340 for attachment of the support plate 126 to the support arm base 202. The bracket 322 can be attached to the support plate 126 by welds at weld locations 338. As an example, the fasteners 340 can include self-tapping screws or bolts configured to be placed into threaded holes within the support arm base 202.

As further shown in FIG. 17, the bracket 322 is attached to the platform 320. The platform 320 can be attached to the support shield extension 310 by welds at weld locations 342. Different and/or additional welds can be used to attach the platform 320 to the support shield extension 310. The bracket 322 and the platform 320 are attached to one another using fasteners 336, removable to allow for removal of the support shield extension 310 to lower a maximum achievable height of the trolley 100. As an example, the fasteners 336 can comprise bolts and nuts. As another example, the fasteners 336 can include bolts, nuts, and washers.

The support shield extension 310 can include fasteners 344 into which other fasteners can be disposed to attach the shield 172 to the support shield extension 310. The brace 312 can be attached to the support shield extension 310 by welds at weld locations 492.

The platform 316 can be attached to the support shield 308 (shown in FIG. 9) by welds at weld locations 348. Different and/or additional welds can be used to attach the platform 316 to the support shield 308. The platform 316 includes through-holes 328 for placement of fasteners 336 for attachment of the bracket 322 to the platform 316 and the support shield 308 when the support shield assembly 352 is removed from the trolley 100. The platform 316 includes a clearance hole 354 to provide clearance for the fastener 318 for attaching the support shield 308 and the platform 316 to the hydraulic lift 300.

FIG. 17 shows fasteners 346 for attachment of the support shield 308 to the support shield assembly 352 (more particularly, the support shield extension 310). As an example, the fasteners 346 can comprise bolts and nuts. As another example, the fasteners 346 can include bolts, nuts, and washers.

The trolley 100 includes a support shield assembly 352 comprising the support shield extension 310, the brace 312, the platform 316, 320, and the fasteners 344.

FIG. 18 shows additional details of the bracket 322. As shown, the bracket 322 includes a bracket wall 296, 298 and a first end 292 (i.e., a first bracket end) and a second end 294 (i.e., a second bracket end). The bracket wall 296, 298 extends from the first end 292 to the second end 294. An height (i.e., elevation of the bracket wall 296, 298 increased as the bracket wall 296, 298 extends from the first end 292 to the second end 294. In other words, the bracket wall 296, 298 is a slanted wall. The placement of the support plate 126 upon the bracket wall 296, 298 results in the support plate 126 as well as the support arm 128, 130, 132 and the roller 176, 178, 180 being tilted with distal ends of the support arm 128, 130 and the roller 176, 178 being higher above the ground as compared to proximal ends of the support arm 128, 130 and the roller 176, 178, which are closer to the support plate 126.

The bracket 322 is configured such that the support plate 126 is tilted relative to the connecting plate 120. The end 486 of the support plate 126 is higher than the end 488 of the support plate 126. This arrangement of the bracket 322, with the support plate 126, the support arm 128, 130, and the roller 176, 178 being tilted allows for a center of mass of a tire, wheel or tire-wheel assembly to be cradled (i.e., to reduce a likelihood of the tire, wheel or tire-wheel assembly from falling of the trolley 100).

FIG. 18 also shows the mounting holes 332 can comprise keyhole slots.

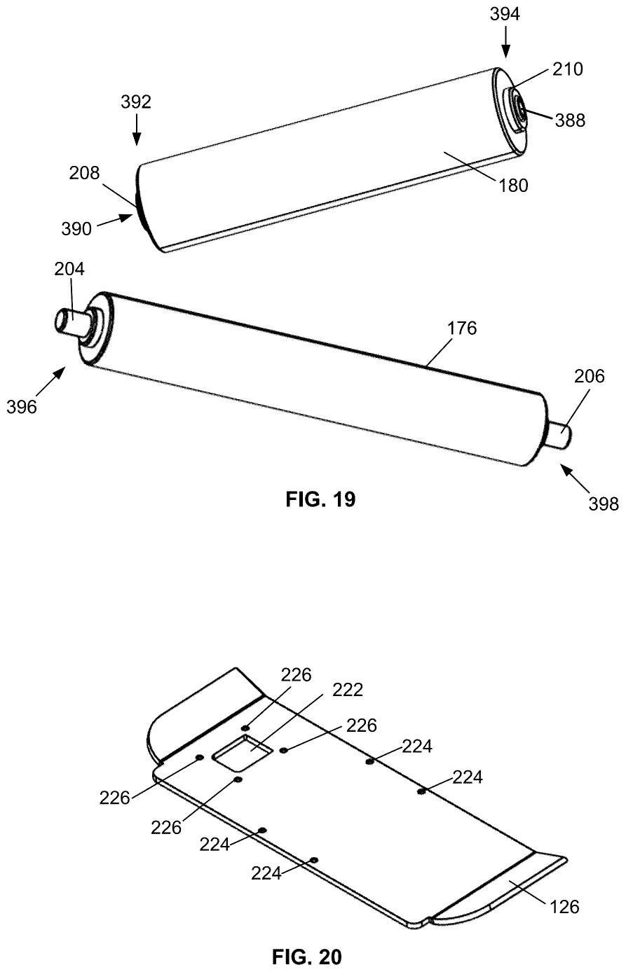

FIG. 19 shows details of the roller 176. As noted, the roller 176 can be identical to the roller 178. The roller 176 includes a retractable post 204 at a first end 396 of the roller 176 and a retractable post 206 at a second end 398 of the roller 176. The first end 396 can be arranged like and look like the second end 398. The retractable post 204 and/or the retractable post 206 can be pushed inward into the roller 176 to allow the roller 176 to be removed from the roller bracket 182, 184 or for attachment to the roller bracket 182, 184. Releasing the retractable post 204, 206 while being pushed extends the retractable post 204, 206 to allow for the roller 176 to be retained by the roller bracket 182, 184.

FIG. 19 also shows details of the roller 180. The roller 180 includes a first end 392, a second end 394. The first end 392 can be arranged like and look like the second end 394. The roller 180 includes a flange 208, 210 and a mounting hole 388, 390 for receipt of the fasteners 408, 410, respectively and identified in FIG. 1.

A person having ordinary skill in the art will understand that, in alternative arrangements, the roller 180 attached to the support arm 132 can be arranged like the roller 176 or some other type of roller, and/or one or more the roller 176, 178 can be arranged like the roller 180 or some other type of roller.

FIG. 20 shows details of the support plate 126. As shown, the support plate 126 includes mounting holes 224 configured for placement of fasteners 228 (identified in FIG. 3 and FIG. 4). As an example, the mounting holes 224 can comprise tapped holes or untapped through-holes. The support plate 126 also includes a through-hole 222 for allowing the support arm 132 to be raised and lowered. The support plate 126 includes mounting holes 226 for placement of the fasteners 242 (identified in FIG. 1) which attach the bracket 236 to the support plate 126. As an example, the mounting holes 226 can comprise tapped holes or untapped through-holes.

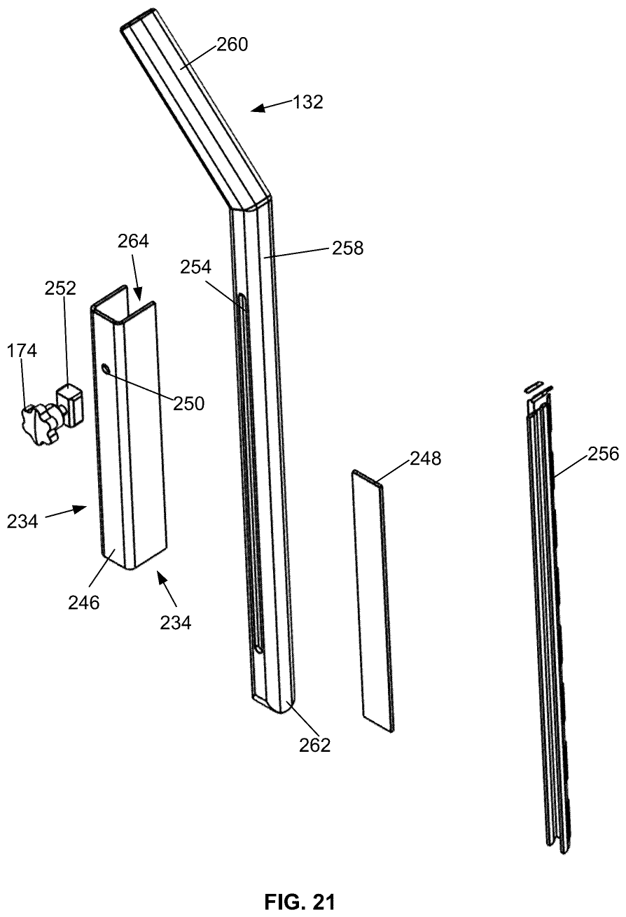

FIG. 21 shows details corresponding to the support arm 132. As shown, the support arm 132 includes a first portion 258 (e.g., a longitudinal portion) and a second portion 260 (e.g., a divergent portion or an angled arm extension) extending from the first portion 258. The support arm 132 can be made from a single metal bar. Alternatively, the support arm 132 can be made from multiple metal bars. The support arm 132 (e.g., the first portion 258) includes a slot 254. The slot 254 is configured for placement of a slot nut 252 attached to the locking fastener 174. Loosening of the locking fastener 174 reduces or removes a force the slot nut 252 applies to the support arm 132 such that the support arm 132 can be moved upward or downward. Tightening of the locking fastener 174 increases a force the slot nut 252 applies to the support arm 132 such that the support arm 132 is not movable upward or downward or makes it harder to move the support arm 132 upward or downward.

FIG. 21 further shows an embodiment in which the sleeve 234 is made from a C-channel 246 and a plate 248. The C-channel 246 includes a through-hole 250 for placement of a portion of the locking fastener 174. Further 20 also shows a rail 256 on which the support arm 132 can ride to assist with upward and downward movement of the support arm 132. The rail 256 can be disposed between a support arm side 262 and an interior wall 264 of the C-channel 246.

The components shown in FIG. 21 along with the roller 180, the roller bracket 190, 192 can be part of and/or referred to as a vertical roller assembly.

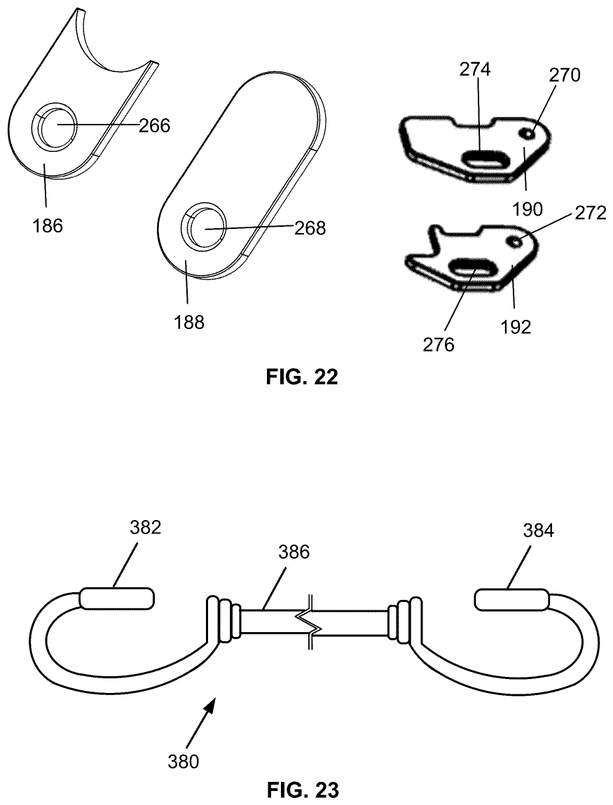

FIG. 22 shows details of the roller bracket 186, 188, 190, 192. The roller bracket 186 includes a mounting hole 266 for placement of the retractable post 204 of the roller 176. The roller bracket 188 includes a mounting hole 268 for placement of the retractable post 206 of the roller 176. In some embodiments, the retractable post 204 contacts the roller bracket 186 directly. In other embodiments, a bushing or bearings are installed within the mounting hole 266, 268 to ease rotation of the roller 176. The roller bracket 190 includes a mounting hole 270 and a slot 274. The roller bracket 192 includes a mounting hole 272 and a slot 276. The slot 274, 276 can be used to retain a hook, such as a hook on a tie-down.

Next, FIG. 23 shows a tie-down 380 including a hook 382, 384 and a cord 386. The hook 382 can be placed within the one of the slot 274 within the roller bracket 190 or the slot 276 within the roller bracket 192, and the hook 384 can be placed with the other one of the slot 274 to the slot 276. The cord 386 can extend around portions of a tire-wheel assembly to help retain the tire-wheel assembly on the trolley 100. Such retention can be useful when rolling the trolley 100 over a floor drain grate within a shop floor, and for other reasons. As an example, the cord 386 can comprise an elastic cord, a fabric, or some other material. The tie-down 380, the roller bracket 190, and the roller bracket 192 form an auxiliary retention system for retaining a tire, wheel, or tire-wheel assembly on the trolley 100. Portions of the tie-down 380 (e.g., the hook 382, 384) can be positioned in the slot 274, 276 when the tie-down 380 is not in use to retain a tire, a wheel, or a tire-wheel assembly to the trolley 100. The tie-down 380 can comprise a bungie cord with hooks.

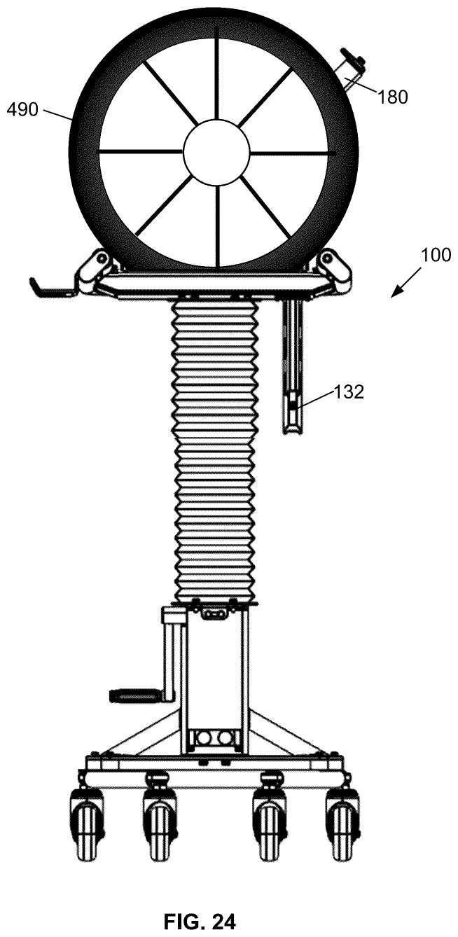

Next, FIG. 24 is an elevation view of trolley 100 and a tire-wheel assembly 490 installed upon the trolley 100. A portion of the roller 180 attached to the support arm 132 is in contact with a sidewall of a tire of the tire-wheel assembly 490.

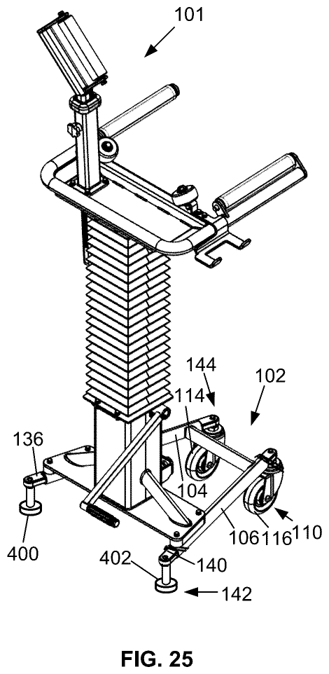

Next, FIG. 25 is a perspective view of a trolley 101. The trolley 101 is arranged like the trolley 100 except that the set of wheel assemblies 110 includes the wheel assembly 114, 116, but does not include the wheel assembly 112, 118, and the trolley 101 includes a peg 400, 402 in place of the wheel assembly 112, 118, respectively. The peg 400 is attached to the longitudinal end 136 and/or the base element 104 proximate the second end 142 of the base 102. Similarly, the peg 402 is attached to the longitudinal end 140 and/or the base element 106 proximate the second end 142 of the base 102. As noted elsewhere in this description, the wheel assembly 114, 116 can each include a caster. In this regard, proximate the second end of the base 102 can be a portion of base 102 closer to the longitudinal end 136, 140 than to the longitudinal end 134, 138. More particularly, proximate the second end of the base 102 can be a portion of base that starts at least within twelve inches of the longitudinal end 134.

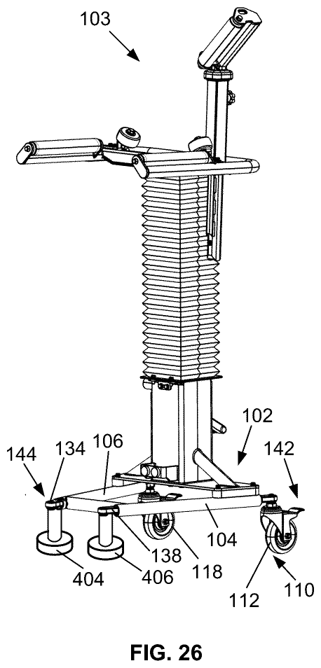

FIG. 26 is a perspective view of a trolley 103. The trolley 103 is arranged like the trolley 100 except that the set of wheel assemblies 110 includes the wheel assembly 112, 118, but does not include the wheel assembly 114, 116, and the trolley 103 includes a peg 404, 406 in place of the wheel assembly 114, 116, respectively. The peg 404 is attached to the longitudinal end 134 and/or the base element 106 proximate the first end 144 of the base 102. Similarly, the peg 406 is attached to the longitudinal end 138 and/or the base element 104 proximate the first end 144 of the base 102. As noted elsewhere in this description, the wheel assembly 112, 118 can each include a caster. In this regard, proximate the first end of the base element 104 can be a portion of base element 104 closer to the longitudinal end 134 than to the longitudinal end 136. More particularly, proximate the first end of the base element 104 can be a portion of base element 104 within twelve inches of the longitudinal end 134.

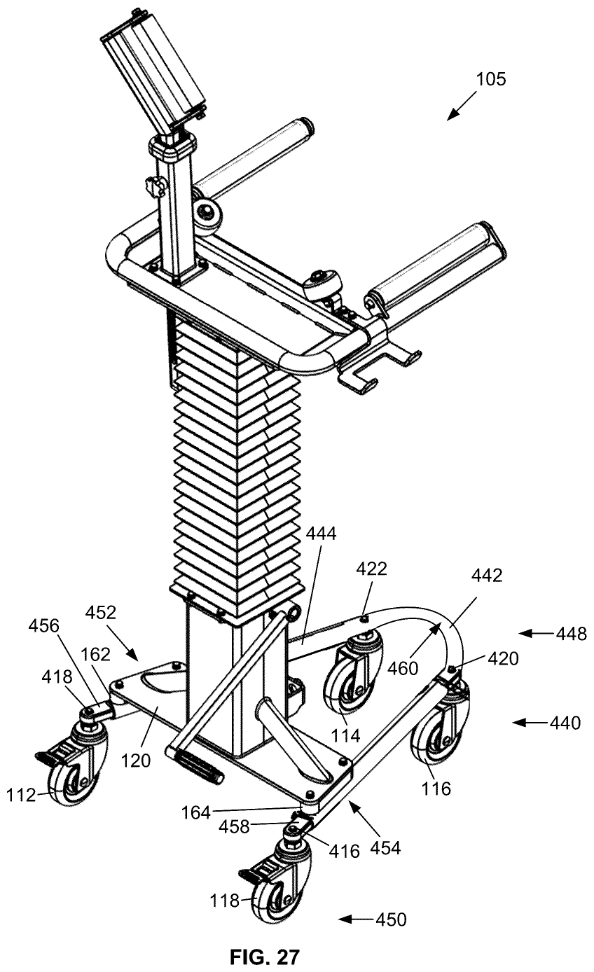

FIG. 27 is a perspective view of a trolley 105. The trolley 105 is arranged like the trolley 100 except that trolley 105 includes a base 440 with base element 442 (i.e., a frame) instead of the base 102 with base element 104, 106, 108. Similar to the base 102, the base 440 includes the wheel assembly 112, 114, 116, 118.

The connecting plate 120 is mounted above and/or upon the base element 442. For example, the connecting plate 120 can be connected to the base element 442 with the spacer 162, 164 located therebetween to allow a first end of a second trolley arranged like the trolley 105 to be nested with the trolley 105 to take less space when storing such trolleys when not in use. The first end of the second trolley can be arranged like a first end 448 shown in FIG. 27. The spacer 162, 164 can be disposed between the connecting plate 120 and a top side 444 of the base element 442.

The base 440 includes the first end 448 (i.e., a first end of the base 440 and/or a first end of the trolley 105) and a second end 450 (i.e., a second end of the base 440 and/or a second end of the trolley 105). The first end 448 is opposite the second end 450. The base 440 includes a first side 452 and a second side 454. The first side 452 is opposite the second side 454. Looking at the trolley 105 proximate the second end 450, the first side 452 can be referred to as a left side of the base 102, and the second side 454 can be referred to as a right side of the base 102.

The base element 442 includes a longitudinal end 456 (i.e., a first longitudinal end and/or a first longitudinal end of the base element 442) and a longitudinal end 458 (i.e., a second longitudinal end and/or a second longitudinal end of the base element 442). The longitudinal end 456, 458 can be arranged like the longitudinal end 136, 140 of the trolley 100.

The base element 442 comprises a metal stock. For example, the base element 442 can comprise a metal bar, a metal rod, a metal pipe, or a metal tube. The metal bar, rod, pipe, or tube can be bent (e.g., bent into a U-shaped bar, rod, pipe or tube, respectively).

FIG. 27 also shows an alternative mounting location 460 at which the first end 448 of the trolley includes a wheel assembly, such as the wheel assembly 114 or a peg, such as the peg 400 (shown in FIG. 25) attached to the base element 442 instead of the wheel assembly 114 and the wheel assembly 116 attached at the first end 448.

### III. Example Operation

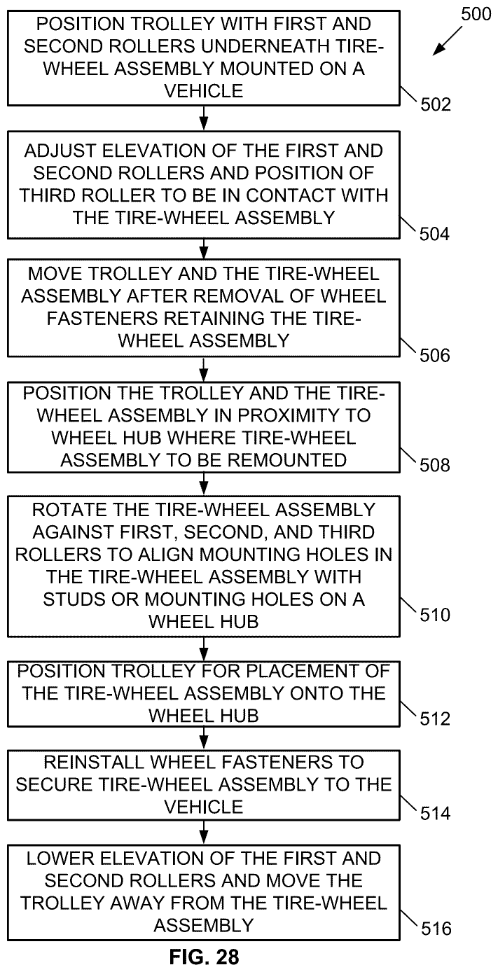

Next, FIG. 28 shows a flow chart 500 including steps of using a trolley in accordance with example embodiments. A method of using a trolley can include performing one or more steps shown in the flow chart 500. The steps are shown in blocks 502 to 516. The placement of blocks within the flow chart 500 does not indicate a required order of performing the steps. As an example, some or all of the steps shown in the flow chart 500 can be performed in a repair shop, such as a tire store, an OEM dealership or retailer, a vehicle fleet repair shop, or some other repair shop.

Block 502 includes positioning a trolley (e.g., the trolley 100, 101, 103, 105) with first and second rollers (e.g., the roller 176 and the roller 178) underneath a tire-wheel assembly mounted on a vehicle. As an example, the vehicle can be raised above a floor of a repair shop using a hydraulic vehicle lift.

Next, block 504 includes adjusting an elevation of the first and second rollers and positioning a third roller (e.g., the roller 180) to be in contact with the tire-wheel assembly. As an example, the first and second rollers can contact a tire tread of the tire-wheel assembly and the third roller can contact a sidewall of the tire-wheel assembly. With the tire-wheel assembly contacting the rollers, a tie-down of the trolley can be used to secure the tire-wheel assembly to the trolley.

Next, block 506 includes moving the trolley and the tire-wheel assembly after removing wheel fasteners (e.g., lug nuts or lug bolts) that retain the tire-wheel assembly to the vehicle (e.g., retained to a wheel hub having threaded wheel studs).

Next, block 508 includes positioning the trolley and the tire-wheel assembly in proximity to the wheel hub where the tire-wheel assembly is to be remounted onto the vehicle. In some cases, a tire on the tire-wheel assembly is replaced before the tire-wheel assembly is to be remounted onto the vehicle.

Next, block 510 includes rotating the tire-wheel assembly against the first, second, and third rollers to align mounting holes in the tire-wheel assembly with studs or mounting holes on a wheel hub of the vehicle.

Next, block 512 includes positioning the trolley for placement of the tire-wheel assembly onto the wheel hub. The wheel hub can be the same wheel hub from which the tire-wheel assembly was removed or a different wheel hub, such as a different wheel hub on the same vehicle.

Next, block 514 includes reinstalling wheel fasteners to secure the tire-wheel assembly to the vehicle.

Next, block 516 includes lowering elevation of the first and second rollers (e.g., the roller 176 and the roller 178) and moving the trolley away from the tire-wheel assembly. As an example, lowering the elevation the first and second rollers can occur by pressing the pedal 302 of the lift actuator downward.

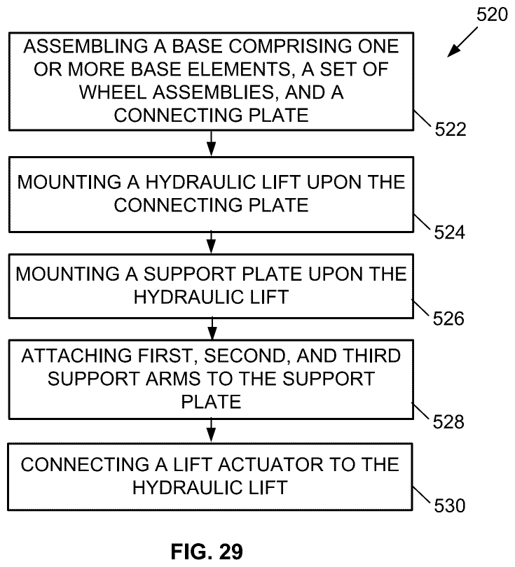

Next, FIG. 29 shows a flow chart 520 including steps for providing a trolley in accordance with example embodiments. A method of providing a trolley can include performing one or more steps shown in the flow chart 520. The steps are shown in blocks 522 to 530. The placement of blocks within the flow chart 520 does not indicate a required order of performing the steps.

Block 522 includes assembling a base comprising one more base elements, a set of wheel assemblies, and a connecting plate. As an example, the one or more base elements comprises a single base element comprises a bent bar, a bent rod, a bent pipe, or a bent tube.

As another example, the one or more base elements includes a first base element, a second base element, and a third base element. Assembling the base includes placing the third base element to extend between the first and second base elements, where a first longitudinal end of the third base element is fixedly attached to the first base element proximate a first end of the base, and a second longitudinal end of the third base element is fixedly attached to the second base element proximate the first end of the base. The first base element and the second base element diverge from each other as the first and second base elements extend in directions toward a second end of the base opposite the first end of the base.

Assembling the base can include mounting the connecting plate 120 upon top sides 154, 156 of the first and second base elements (e.g., base elements 106, 104) proximate the second end 142 of the base 102. In some cases, the connecting plate 120 can be mounted directly onto the top sides 154, 156 of the first and second base elements. In other cases, spacers 162, 164 can be installed between the connecting plate 120 and the top sides 154, 156 of the first and second base elements. Fasteners 216 can be used to secure the connecting plate 120 (or the connecting plate 120 and the spacers 162, 164) to the top sides 154, 156 of the first and second base elements. Alternatively, assembling the base can include mounting the connecting plate 120 upon a top side of the single base element (e.g., the base element 442) proximate the second end 450 of the base 440.

Assembling the base can include attaching the set of wheel assemblies to keep the first, second, and third base elements above a ground surface below the first, second, and third base elements. As an example, attaching the set of wheels can include attaching the wheel assemblies 116, 118 to the base element 104, and attaching the wheel assemblies 112, 114 to the base element 106. Alternatively, assembling the base can include attaching the set of wheel assemblies to keep the single base element (e.g., a frame) above a ground surface below the first single base element.

Next, block 524 includes mounting a hydraulic lift upon the connecting plate. As an example, mounting the hydraulic lift 300 upon the connecting plate 120 can include installing one or more fasteners 220 from an underside of and through the connecting plate 120 into a bottom side of the hydraulic lift 300.

Next, block 526 includes mounting a support plate upon the hydraulic lift. As an example, mounting the support plate 126 upon the hydraulic lift 300 can include attaching a platform 316 to the piston 306 of the hydraulic lift 300, and attaching a bracket 322 to the support plate 126. In accordance with this example, the bracket 322 can be attached to the platform 316 using fasteners 336 so that the support plate 126 is mounted upon the hydraulic lift 300. Alternatively, a support shield extension 310 can be attached to the bracket 322 using the fasteners 336 and to a support shield 308 connected to or including the platform 316 using fasteners 346 so that the support plate 126 is mounted upon the hydraulic lift 300.

Next, block 528 includes attaching first, second, and third support arms to the support plate. As an example, the third support arm (e.g., the support arm 132) extends upward from the support plate 126. As another example, the first and second support arms (e.g., the support arms 128, 130) extend away from the support plate 126 and substantially orthogonal to the third support arm.

Next, block 530 includes connecting a lift actuator to the hydraulic lift. As an example, the lift actuator can include the pedal 302, the lever arm 304, and the sleeve 356. The sleeve 356 can be attached to the plunger actuator retainer 358, which is attached to the plunger actuator 360.

### IV. Example Vehicle

A vehicle is a mobile machine that can be used to transport a person, people, and/or cargo. A vehicle can be driven and/or otherwise guided along a path (e.g., a paved road or otherwise) on land, in water, in the air, and/or outer space. A vehicle can be wheeled, tracked, railed, and/or skied. A vehicle can include an automobile, a motorcycle (e.g., a two or three wheel motorcycle), an all-terrain vehicle (ATV) defined by ANSI/SVIA-1-2007, a light-duty truck, a medium-duty truck, a heavy-duty truck, an on-highway truck, a semi-tractor, and/or a farm machine. Many vehicles have multiple tire-wheel assemblies. Such tire-wheel assemblies are removable and reinstallable. The tire trollies of the example embodiments can hold tire-wheel assemblies while removed from the vehicle.

### V. CONCLUSION

The arrangements described herein and/or shown in the drawings are for purposes of example and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein is for the purpose of describing example embodiments, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” and “one or more of the following” immediately preceding a list of at least two components or functions is to cover each implementation including a listed component or function independently and each implementation including a combination of the listed components or functions. For example, an implementation described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an implementation including A, but not B and not C, (ii) an implementation including B, but not A and not C, (iii) an implementation including C, but not A and not B, (iv) an implementation including A and B, but not C, (v) an implementation including A and C, but not B, (v) an implementation including B and C, but not A, and/or (vi) an implementation including A, B, and C. For the embodiments including component or function A, the embodiments can include one A or multiple A. For the embodiments including component or function B, the embodiments can include one B or multiple B. For the embodiments including component or function C, the embodiments can include one C or multiple C. The use of ordinal numbers such as “first,” “second,” “third” and so on is to distinguish respective elements rather than to denote an order of those elements unless the context of using those terms explicitly indicates otherwise.

Implementations of the present disclosure may thus relate to one of the enumerated example embodiments (EEEs) listed below.

EEE 1 is a trolley. The trolley includes a base comprising: first and second base elements, a set of wheel assemblies, and a connecting plate. The trolley includes a hydraulic lift mounted upon the connecting plate. The trolley includes a support plate mounted upon the hydraulic lift. The trolley includes first, second, and third support arms fixedly attached to the support plate. The trolley also includes a lift actuator configured to alter fluid pressure within the hydraulic lift. The first base element and the second base element diverge from each other as the first and second base elements extend in directions toward a second end of the base opposite the first end of the base. The connecting plate is mounted upon top sides of the first and second base elements proximate the second end of the base. The third support arm extends upward from the support plate. The first and second support arms extend away from the support plate and substantially orthogonal to the third support arm. The set of wheel assemblies is arranged to keep the first and second base elements above a ground surface below the first and second base elements.

EEE 2 is the trolley of EEE 1, further comprising: a hydraulic lift shield configured to transmit lateral forces to the base; and first and second braces fixedly attached to the connecting plate and to the hydraulic lift shield.

EEE 3 is the trolley of EEE 2, wherein: the first brace extends from the hydraulic lift shield towards the connecting plate and the first base element, and the second brace extends from the hydraulic lift shield towards the connecting plate and the second base element.

EEE 4 is the trolley of any one of EEE 1 to 3, wherein: the first base element comprises a first metal stock selected from the group consisting of a metal bar, a metal rod, a metal pipe, and a metal tube, and the second base element comprises a second metal stock selected from the group consisting of a metal bar, a metal rod, a metal pipe, and a metal tube.

EEE 5 is the trolley of any one of EEE 1 to 4, wherein: the set of wheel assemblies includes first, second, third, and fourth wheel assemblies, the first and second base elements comprise first and second metal stock, respectively, both ends of the first and second metal stock are machined to have upper and lower flat surfaces, the first and second wheel assemblies contact the lower flat surfaces of the first metal stock, the third and fourth wheel assemblies contact the lower flat surfaces of the second metal stock, fasteners disposed proximate the upper flat surfaces of the first stock affix the first and second wheel assemblies to the first metal stock, fasteners disposed proximate the upper flat surfaces of the second stock affix the third and fourth wheel assemblies to the second metal stock, the first metal stock comprises a first bar or rod, and the second metal stock comprises a second bar or rod.

EEE 6 is the trolley of any one of EEE 1 to 5, further comprising: first, second, third, and fourth mounting extensions, wherein: the set of wheel assemblies includes first, second, third, and fourth wheel assemblies, the first base element comprises a first metal tube or pipe having first and second open ends, the second base element comprises a second metal tube or pipe having first and second open ends, the first mounting extension is attached to the first wheel assembly via a first fastener and is partially positioned within the first open end of the first base element, the second mounting extension is attached to the second wheel assembly via a second fastener and is partially positioned within the second open end of the first base element, the third mounting extension is attached to the third wheel assembly via a third fastener and is partially positioned within the first open end of the second base element, and the fourth mounting extension is attached to the fourth wheel assembly via a fourth fastener and is partially positioned within the second open end of the second base element.

EEE 7 is the trolley of EEE 1, further comprising: first and second pegs, wherein: the set of wheel assemblies includes first and second wheel assemblies, and the set of wheel assemblies are proximate the first end of the base and first and second pegs proximate the second end of the base, or the set of wheel assemblies are proximate the second end of the base and first and second pegs proximate the first end of the base.

EEE 8 is the trolley of EEE 7, wherein the first and second wheel assemblies comprise first and second casters, respectively.

EEE 9 is the trolley of any one of EEE 1 to 8, wherein: a first plane passes through the first and second base elements, a second plane passes through the first and second support arms, and the first plane is substantially parallel to the second plane.

EEE 10 is the trolley of any one of EEE 1 to 9, further comprising: first and second spacers, wherein: the first spacer is disposed between the first base element and the connecting plate and contacts a top side of the first base element and a bottom side of the connecting plate, and the second spacer is disposed between the second base element and the connecting plate and contacts the top side of the second base element and the bottom side of the connecting plate, whereby portions of first and second base elements of a second trolley arranged like the trolley can pass under the connecting plate and in between the first and second base elements of the trolley.

EEE 11 is the trolley of EEE 10, wherein: the first spacer is welded to the first base element, the second spacer is welded to the second base element, and the connecting plate is fastened to the first spacer and the second spacer, or to the first base element and the second base element.

EEE 12 is the trolley of any one of EEE 10 to 11, further comprising: first fasteners disposed within first through-holes in the connecting plate, through-holes within the first spacer, and within mounting holes in the top side of the first base element, and second fasteners disposed within second through-holes in the connecting plate, through-holes within the second spacer, and within mounting holes in the top side of the second base element.

EEE 13 is the trolley of any one of EEE 1 to 12, wherein: the first and second base elements extend upward as the first and second base elements extend in directions toward the second end of the base opposite the first end of the base.

EEE 14 is the trolley of any one of EEE 1 to 13, wherein: the first longitudinal end of the connecting plate is disposed above the first base element, and the second longitudinal end of the connecting plate is disposed above the second base element.

EEE 15 is the trolley of any one of EEE 1 to 14, wherein: the trolley is a first trolley, a second trolley is arranged like the first trolley and includes a first end of the second trolley, and a portion of a base of the second trolley, starting from the first end of the second trolley, is configured to slide between the first and second elements of the first trolley and underneath the connecting plate of the first trolley when the first and second rollers of the first trolley are set at least a first distance above or below a height of first and second rollers of the second trolley.

EEE 16 is a trolley. The trolley includes a base comprising: a frame having first and second longitudinal end sides, and first and second longitudinal portions between the first and second longitudinal end sides, a set of wheel assemblies, and a connecting plate. The trolley also includes a hydraulic lift mounted upon the connecting plate; a support plate mounted upon the hydraulic lift; first, second, and third support arms fixedly attached to the support plate; and a lift actuator configured to alter fluid pressure within the hydraulic lift. The first longitudinal end side is opposite the second longitudinal end side. The first longitudinal portion and the second longitudinal portion diverge from each other as the first and second longitudinal portions extend in directions toward the second longitudinal end side away from the first longitudinal end side. The connecting plate is mounted upon top sides of the first and second longitudinal portions proximate the second longitudinal end side of the frame. The third support arm extends upward from the support plate. The first and second support arms extend away from the support plate and substantially orthogonal to the third support arm. The set of wheel assemblies is arranged to keep the frame above a ground surface below the frame.

EEE 17 is the trolley of EEE 16, wherein the frame comprises a bent bar, a bent rod, a bent pipe, or a bent tube.

EEE 18 is the trolley of EEE 16, wherein: the first longitudinal portion comprises a first frame element, the second longitudinal portion comprises a second frame element, and an attachment of the first frame element to the second frame element occurs at or proximate the first longitudinal end side of the frame.

EEE 19 is the trolley of EEE 18, wherein: the base comprises a third frame element that extends between the first frame element and the second frame element, and the attachment of the first frame element to the second frame element occurs via the third frame element.

EEE 20 is the trolley of EEE 18, wherein the attachment of the first frame element to the second frame element occurs via welding or one or more fasteners.

EEE 21 is the trolley of any one of EEE 16 to 20, wherein: the trolley is a first trolley, a second trolley is arranged like the first trolley and includes a first end of the second trolley, and a portion of a base of the second trolley, starting from the first end of the second trolley, is configured to slide between the first and second longitudinal portions of the first trolley and underneath the connecting plate of the first trolley when the first and second rollers of the first trolley are set at least a first distance above or below a height of first and second rollers of the second trolley.

EEE 22 is the trolley of any one of EEE 1 to 21, further comprising: a U-shaped bar or pipe mounted on the support plate, wherein the first and second support arms are on opposite ends of the U-shaped bar or pipe.

EEE 23 is the trolley of any one of EEE 1 to 22, further comprising: a first roller attached to the first support arm; and a second roller attached to the second support arm.

EEE 24 is the trolley of EEE 23, further comprising: a third roller attached to the third support arm.

EEE 25 is the trolley of EEE 24, wherein: a position of the third support arm is adjustable so that the third roller can be positioned in contact with at least a portion of a sidewall of a tire positioned on the first and second rollers.

EEE 26 is the trolley of EEE 25, wherein the tire is mounted on a wheel.

EEE 27 is the trolley of EEE 26, wherein a center of mass of the trolley is offset from the hydraulic lift when the tire is positioned on the first and second rollers.

EEE 28 is the trolley of any one of EEE 1 to 27, further comprising: one or more supplemental rollers attached to the support plate, wherein the one or more supplemental rollers are configured for contacting at least a portion of a sidewall of a tire positioned on the first and second rollers or a wheel to which the tire is attached.

EEE 29 is the trolley of any one of EEE 1 to 28, wherein: the support plate includes first and second ends of the support plate opposite one another, the first end of the support plate, rather than the second end of the support plate, is closer to the first end of the base, the support plate is tilted relative to the connecting plate, and the first end of the support plate is higher than the second end of the support plate.

EEE 30 is the trolley of any one of EEE 1 to 29, further comprising: a support shield extension removably attached to the hydraulic lift and to the support plate, wherein the support shield extension is disposed between the hydraulic lift and the support plate to elevate the support plate.

EEE 31 is the trolley of any one of EEE 1 to 30, further comprising: a tie-down; first and second roller brackets; a roller attached to the first and second roller brackets. The first and second roller brackets are attached to an angled arm extension of the third support arm. The first roller bracket includes a first through-hole adapted for attaching a first portion of the tie-down. The second roller bracket includes a second through-hole adapted for attaching a second portion of the tie-down. The tie-down is configured to retain a tire, a wheel, or a tire-wheel assembly to the trolley.

EEE 32 is the trolley of EEE 31, wherein: the first roller bracket includes a first slot, the second roller bracket includes a second slot, and portions of the tie-down are positioned in the first slot and the second slot when the tie-down is not in use to retain a tire, a wheel, or a tire-wheel assembly to the trolley.

EEE 33 is the trolley of any one of EEE 1 to 32, further comprising: a third base element. The third base element extends between the first and second base elements. A first longitudinal end of the third base element is fixedly attached to the first base element proximate a first end of the base. A second longitudinal end of the third base element is fixedly attached to the second base element proximate the first end of the base.

EEE 34 is the trolley of EEE 33, wherein the set of wheel assemblies is arranged to keep the third base element above the ground surface below the third base element.

EEE 35 is the trolley of any one of EEE 33 to 34, wherein the third base element comprises a third metal stock selected from the group consisting of a metal bar, a metal rod, a metal pipe, and a metal tube.

EEE 36 is the trolley of any one of EEE 1 to 35, further comprising: a first shield surrounding at least a portion of the hydraulic lift; a second shield configured for movement within a gap between the first shield and the hydraulic lift, and a set of plain bearings. The set of plain bearings are configured to transfer lateral forces to the first shield.

EEE 37 is the trolley of EEE 36, wherein the set of plain bearings include at least one plain bearing on each of four sides of the second shield.

EEE 38 is the trolley of any one of EEE 36 to 37, wherein each plain bearing of the set of plain bearings is made of polyethylene.

EEE 39 is a method comprising positioning a trolley with first and second rollers underneath a tire-wheel assembly mounted on a vehicle. The method includes adjusting an elevation of the first and second rollers and positioning a third roller to be in contact with the tire-wheel assembly. The method includes moving the trolley and the tire-wheel assembly after removal of lug nuts retaining the tire-wheel assembly. The method also includes positioning the trolley and the tire-wheel assembly in proximity to the wheel hub where the tire-wheel assembly is to be remounted. The method further includes rotating the tire-wheel assembly against the first, second and third rollers to align mounting holes in the tire-wheel assembly onto the wheel hub. Additionally, the method includes reinstalling lug nuts on wheel studs on the wheel hub to secure the tire-wheel assembly to the vehicle. Further, the method includes lowering an elevation of the first and second rollers and moving the trolley away from the tire-wheel assembly.

EEE 40 is a method comprising positioning a trolley with first and second rollers underneath a tire-wheel assembly mounted on a vehicle. The method includes adjusting an elevation of the first and second rollers and positioning a third roller to be in contact with the tire-wheel assembly. The method includes moving the trolley and the tire-wheel assembly after removal of lug nuts retaining the tire-wheel assembly. The method also includes positioning the trolley and the tire-wheel assembly in proximity to the wheel hub where the tire-wheel assembly is to be remounted. The method further includes rotating the tire-wheel assembly against the first, second and third rollers to align mounting holes in the tire-wheel assembly onto the wheel hub. Additionally, the method includes reinstalling lug nuts on wheel studs on the wheel hub to secure the tire-wheel assembly to the vehicle. Further, the method includes lowering an elevation of the first and second rollers and moving the trolley away from the tire-wheel assembly, wherein the trolley is arranged like the trolley in any one of EEE 1 to 38.

EEE 41 is a method comprising assembling a base comprising one or more base elements, a set of wheel assemblies, and a connecting plate. The method also includes mounting a hydraulic lift upon the connecting plate. The method also includes mounting a support plate upon the hydraulic lift. Further, the method includes attaching first, second and third support arms to the support plate. Furthermore, the method includes connecting a lift actuator to the hydraulic lift.

EEE 42 is a method comprising assembling a base comprising one or more base elements, a set of wheel assemblies, and a connecting plate. The method also includes mounting a hydraulic lift upon the connecting plate. The method also includes mounting a support plate upon the hydraulic lift. Further, the method includes attaching first, second and third support arms to the support plate. Furthermore, the method includes connecting a lift actuator to the hydraulic lift, wherein the base, the hydraulic lift, the support plate, the first, second, and third support arms, and the lift actuator are components of a trolley arranged like the trolley in any one of EEE 1 to 38.

1. A trolley comprising:
a base comprising:
first and second base elements,
a set of wheel assemblies, and
a connecting plate;
a hydraulic lift mounted upon the connecting plate;
a support plate mounted upon the hydraulic lift;
first, second, and third support arms attached to the support plate; and
a lift actuator configured to alter fluid pressure within the hydraulic lift, wherein:
the first base element and the second base element diverge from each other as the first and second base elements extend in directions toward a second end of the base opposite the first end of the base,
the connecting plate is mounted upon top sides of the first and second base elements proximate the second end of the base,
the third support arm extends upward from the support plate,
the first and second support arms extend away from the support plate and substantially orthogonal to the third support arm, and
the set of wheel assemblies is arranged to keep the first and second base elements above a ground surface below the first and second base elements.

2. The trolley of claim 1, further comprising:
a hydraulic lift shield configured to transmit lateral forces to the base; and
first and second braces fixedly attached to the connecting plate and to the hydraulic lift shield.

3. The trolley of claim 1, wherein:
the first base element comprises a first metal stock selected from the group consisting of a metal bar, a metal rod, a metal pipe, and a metal tube, and
the second base element comprises a second metal stock selected from the group consisting of a metal bar, a metal rod, a metal pipe, and a metal tube.

4. The trolley of claim 1, wherein:
the set of wheel assemblies includes first, second, third, and fourth wheel assemblies,
the first and second base elements comprise first and second metal stock, respectively,
both ends of the first and second metal stock are machined to have upper and lower flat surfaces,
the first and second wheel assemblies contact the lower flat surfaces of the first metal stock,
the third and fourth wheel assemblies contact the lower flat surfaces of the second metal stock,
fasteners disposed proximate the upper flat surfaces of the first stock affix the first and second wheel assemblies to the first metal stock,
fasteners disposed proximate the upper flat surfaces of the second stock affix the third and fourth wheel assemblies to the second metal stock,
the first metal stock comprises a first bar or rod, and
the second metal stock comprises a second bar or rod.

5. The trolley of claim 1, further comprising:
first, second, third, and fourth mounting extensions, wherein:
the set of wheel assemblies includes first, second, third, and fourth wheel assemblies,
the first base element comprises a first metal tube or pipe having first and second open ends,
the second base element comprises a second metal tube or pipe having first and second open ends,
the first mounting extension is attached to the first wheel assembly via a first fastener and is partially positioned within the first open end of the first base element,
the second mounting extension is attached to the second wheel assembly via a second fastener and is partially positioned within the second open end of the first base element,
the third mounting extension is attached to the third wheel assembly via a third fastener and is partially positioned within the first open end of the second base element, and
the fourth mounting extension is attached to the fourth wheel assembly via a fourth fastener and is partially positioned within the second open end of the second base element.

6. The trolley of claim 1, further comprising:
first and second pegs, wherein:
the set of wheel assemblies includes first and second wheel assemblies, and
the set of wheel assemblies are proximate the first end of the base and first and second pegs proximate the second end of the base, or the set of wheel assemblies are proximate the second end of the base and first and second pegs proximate the first end of the base.

7. The trolley of claim 1, wherein:
a first plane passes through the first and second base elements,
a second plane passes through the first and second support arms, and
the first plane is substantially parallel to the second plane.

8. The trolley of claim 1, further comprising:
first and second spacers, wherein:
the first spacer is disposed between the first base element and the connecting plate and contacts a top side of the first base element and a bottom side of the connecting plate, and
the second spacer is disposed between the second base element and the connecting plate and contacts the top side of the second base element and the bottom side of the connecting plate,
whereby portions of first and second base elements of a second trolley arranged like the trolley can pass under the connecting plate and in between the first and second base elements of the trolley.

9. The trolley of claim 1, wherein:
the first and second base elements extend upward as the first and second base elements extend in directions toward the second end of the base opposite the first end of the base.

10. The trolley of claim 1, wherein:
the first longitudinal end of the connecting plate is disposed above the first base element, and
the second longitudinal end of the connecting plate is disposed above the second base element.

11. The trolley of claim 1, further comprising:
a U-shaped bar or pipe mounted on the support plate, wherein the first and second support arms are on opposite ends of the U-shaped bar or pipe.

12. The trolley of claim 1, further comprising:
a first roller attached to the first support arm; and
a second roller attached to the second support arm.

13. The trolley of claim 1, further comprising:
one or more supplemental rollers attached to the support plate, wherein the one or more supplemental rollers are configured for contacting at least a portion of a sidewall of a tire positioned on the first and second rollers or a wheel to which the tire is attached.

14. The trolley of claim 1, wherein:
the support plate includes first and second ends of the support plate opposite one another,
the first end of the support plate, rather than the second end of the support plate, is closer to the first end of the base,
the support plate is tilted relative to the connecting plate, and
the first end of the support plate is higher than the second end of the support plate.

15. The trolley of claim 1, further comprising:
a support shield extension removably attached to the hydraulic lift and to the support plate, wherein the support shield extension is disposed between the hydraulic lift and the support plate to elevate the support plate.

16. The trolley of claim 1, further comprising:
a tie-down;
first and second roller brackets;
a roller attached to the first and second roller brackets, wherein:
the first and second roller brackets are attached to an angled arm extension of the third support arm, and
the first roller bracket includes a first through-hole adapted for attaching a first portion of the tie-down,
the second roller bracket includes a second through-hole adapted for attaching a second portion of the tie-down, and
the tie-down is configured to retain a tire, a wheel, or a tire-wheel assembly to the trolley.

17. The trolley of claim 1, wherein:
the trolley is a first trolley,
a second trolley is arranged like the first trolley and includes a first end of the second trolley, and
a portion of a base of the second trolley, starting from the first end of the second trolley, is configured to slide between the first and second elements of the first trolley and underneath the connecting plate of the first trolley when the first and second rollers of the first trolley are set at least a first distance above or below a height of first and second rollers of the second trolley.

18. The trolley of claim 1, further comprising:
a third base element, wherein:
the third base element extends between the first and second base elements,
a first longitudinal end of the third base element is fixedly attached to the first base element proximate a first end of the base, and
a second longitudinal end of the third base element is fixedly attached to the second base element proximate the first end of the base.

19. The trolley of claim 1, further comprising:
a first shield surrounding at least a portion of the hydraulic lift;
a second shield configured for movement within a gap between the first shield and the hydraulic lift; and
a set of plain bearings, wherein:
the set of plain bearing are configured to transfer lateral forces to the first shield.

20. A trolley comprising:
a base comprising:
a frame having first and second longitudinal end sides, and first and second longitudinal portions between the first and second longitudinal end sides,
a set of wheel assemblies, and
a connecting plate;
a hydraulic lift mounted upon the connecting plate;
a support plate mounted upon the hydraulic lift;
first, second, and third support arms attached to the support plate; and
a lift actuator configured to alter fluid pressure within the hydraulic lift, wherein:
the first longitudinal end side is opposite the second longitudinal end side,
the first longitudinal portion and the second longitudinal portion diverge from each other as the first and second longitudinal portions extend in directions toward the second longitudinal end side away from the first longitudinal end side,
the connecting plate is mounted upon top sides of the first and second longitudinal portions proximate the second longitudinal end side of the frame,
the third support arm extends upward from the support plate,
the first and second support arms extend away from the support plate and substantially orthogonal to the third support arm, and
the set of wheel assemblies is arranged to keep the frame above a ground surface below the frame.

21. The trolley of claim 20, wherein the frame comprises a bent bar, a bent rod, a bent pipe, or a bent tube.

22. The trolley of claim 20, wherein:
the first longitudinal portion comprises a first frame element,
the second longitudinal portion comprises a second frame element, and
an attachment of the first frame element to the second frame element occurs at or proximate the first longitudinal end side of the frame.
